(19) United States
(12) Patent Application Publication
(10) Pub. No.: US 2025/0047330 A1
(43) Pub. Date: Feb. 6, 2025

(54) METHOD AND APPARATUS FOR NETWORK CODING-BASED HARQ IN MULTIPLE MIMO LAYERS

(71) Applicant: HUAWEI TECHNOLOGIES CO., LTD., Shenzhen (CN)

(72) Inventors: Yu CAO, Kanata (CA); Jianglei MA, Kanata (CA); Ming JIA, Kanata (CA)

(21) Appl. No.: 18/926,472

(22) Filed: Oct. 25, 2024

Related U.S. Application Data
(63) Continuation of application No. PCT/CN2022/089263, filed on Apr. 26, 2022.

(51) Int. Cl. H04B 7/0413

(52) U.S. Cl. CPC H04B 7/0413

(57) ABSTRACT

Methods and apparatuses for performing MIMO transmissions are described. Retransmission schemes are described for MIMO transmissions. In an example, a transmitter node obtains a plurality of packets to be transmitted to an intended receiver node over a plurality of MIMO layers. A set of one or more cross-block check blocks is generated, where the set of one or more cross-block check blocks being is using a plurality of bits selected from across two or more packets to be transmitted over respective two or more MIMO layers. The set of one or more cross-block check blocks is transmitted over one or more MIMO layers.

### CROSS-REFERENCE TO RELATED APPLICATION

This application is a continuation of International Application No. PCT/CN2022/089263, filed on Apr. 26, 2022, the disclosure of which is hereby incorporated by reference in its entirety.

### FIELD

The present disclosure relates to methods and apparatuses for wireless communications using multiple-input multiple-output (MIMO) transmissions, including MIMO transmissions with network coding.

### BACKGROUND

An important application in existing and planned future wireless communication systems is ultra-reliable low-latency communication (URLLC) applications. A challenge in URLLC applications is the problem of how to reliably communicate a large packet (i.e., having large data size) within a stringent delay limit. Examples of applications having such a challenge include extended reality (XR) applications, remote robotic control applications, and real-time gaming applications, among others.

To achieve the high reliability required of URLLC applications, the communication protocol typically adopts a retransmission scheme that uses certain repetition and diversity techniques. However, for URLLC applications that require communication of large packets, existing retransmission schemes (which typically require multiple retransmissions, and use transport block (TB) or code block group (CBG) based feedback) may not satisfy the stringent delay and reliability requirements.

Network coding-based coding schemes may help to satisfy the reliability requirement using multiple initial transmissions, however the use of multiple initial transmissions may introduce additional delay.

Accordingly, it would be useful to provide a solution to help address the challenge of communicating large packets in URLLC applications.

### SUMMARY

MIMO and multiple transmission and reception point (TRP) communications have been proposed for large packet URLLC applications, to help improve throughput by using multiple MIMO layers, and to help increase reliability via diversity gain. MIMO and multi-TRP-based retransmission schemes may help address challenges imposed by large packet URLLC applications. In particular, the present disclosure describes a MIMO retransmission scheme that may enable more efficient use of transmission resources (e.g., time and frequency resources), compared to conventional HARQ retransmission schemes.

In some examples, the present disclosure describes retransmission schemes in which cross-block check blocks are generated using information bits selected from across multiple packets that are transmitted over multiple MIMO layers. Cross-block check blocks that are generated using bits selected from across multiple packets (which are subsequently mapped to multiple MIMO layers) may also be referred to as cross-layer check blocks, multi-layer cross-block check blocks, or multi-layer vertical check blocks.

In some examples, the present disclosure also describes retransmission schemes in which cross-block check blocks are generated using information bits selected from across multiple code blocks of a packet mapped to one MIMO layer. Cross-block check blocks that are generated using bits selected from across multiple code blocks of a packet mapped to one MIMO layer may also be referred to as single-layer cross-block check blocks, single-layer check blocks or single-layer vertical check blocks.

The term cross-block check block may generally encompass both multi-layer cross-block check blocks and single-layer cross-block check blocks, as disclosed herein. Further, in some examples the term check block may be understood to encompass coded bits that are generated using any suitable combination of bits (e.g., not necessarily limited to encoding using a channel code). The cross-block check blocks may be used (e.g., in retransmissions) to assist in decoding of the packets.

The use of multi-layer cross-block check blocks for retransmissions enables a single retransmission to provide information to assist in decoding of packets transmitted across multiple MIMO layers, which may enable successful decoding of received packets at a receiver node using fewer retransmissions. The use of single-layer cross-block check blocks for retransmissions enables layer-specific feedback, which may enable retransmissions that are more specific to a specific MIMO layer and may result in more effective retransmissions.

In an example aspect, the present disclosure describes a method, at a transmitter node, the method including: obtaining a plurality of packets to be transmitted to an intended receiver node over a plurality of multiple-input multiple-output (MIMO) layers; generating a set of one or more cross-block check blocks, the set of one or more cross-block check blocks being generated using a plurality of bits selected from across two or more packets to be transmitted over respective two or more MIMO layers; and transmitting the set of one or more cross-block check blocks over one or more MIMO layers.

In an example of the preceding example aspect of the method, the method may further include: transmitting at least one of the plurality of packets over at least one MIMO layer in an initial transmission, the at least one MIMO layer being a first subset of available MIMO layers at the transmitter node; where the set of one or more cross-block check blocks may be transmitted over a second subset of the available MIMO layers at the transmitter node, and the set of one or more cross-block check blocks may be transmitted with the at least one of the plurality of packets in the initial transmission.

In an example of a preceding example aspect of the method, the method may further include: transmitting at least one of the plurality of packets over at least one MIMO layer in an initial transmission; and transmitting the set of one or more cross-block check blocks over one or more MIMO layers in a retransmission.

In an example of the preceding example aspect of the method, the method may further include: receiving feedback from the intended receiver node indicating decoding of at least one packet was unsuccessful, where the feedback may be non-specific to any MIMO layer; and where the retransmission may be performed in response to the received feedback.

In an example of a preceding example aspect of the method, the set of one or more cross-block check blocks may be transmitted in the retransmission in absence of any feedback from the intended receiver node.

In an example of any of the preceding example aspects of the method, the plurality of bits selected from different packets may be selected using a set of interleavers associated with a redundancy version (RV) index.

In an example of the preceding example aspect of the method, the method may further include: generating the set of one or more cross-block check blocks includes generating a first set of one or more cross-block check blocks using a first plurality of bits selected across the two or more packets using a first set of interleavers associated with a first RV index, and generating a second set of one or more cross-block check blocks using a second plurality of bits selected across the two or more packets using a second set of interleavers associated with a second RV index; and transmitting the set of one or more cross-block check blocks includes transmitting the first set of one or more cross-block check blocks over a first set of one or more MIMO layers, and transmitting the second set of one or more cross-block check blocks over a second set of one or more MIMO layers in a same transmission.

In an example of any of the preceding example aspects of the method, a first packet of the plurality of packets may be mapped to a first MIMO layer using a first modulation and coding scheme (MCS) and a second packet of the plurality of packets may be mapped to a second MIMO layer using a second MCS different from the first MCS.

In an example of any of the preceding example aspects of the method, the transmitter node may be a base station or a user equipment (UE).

In another example aspect, the present disclosure describes a method, at a first transmitter node, the method including: obtaining a plurality of packets intended to be transmitted to an intended receiver node; where the first transmitter node is configured to cooperate with a second transmitter node to transmit the plurality of packets to the intended receiver node over a plurality of multiple-input multiple-output (MIMO) layers; and where the first transmitter node cooperates with the second transmitter node by: generating a set of cross-block check blocks, the set of cross-block check blocks being generated using a plurality of bits selected from across two or more of the plurality of packets to be transmitted over respective two or more MIMO layers; and transmitting one or more cross-block check blocks of the set of cross-block check blocks to one of the intended receiver node or the second transmitter node.

In an example of the preceding example aspect of the method, the method may further include: transmitting the plurality of packets to the intended receiver node over the plurality of MIMO layers; where the set of cross-block check blocks may be transmitted to the second transmitter node.

In an example of a preceding example aspect of the method, the method may further include: transmitting the plurality of packets to the second transmitter node; and transmitting configuration information to the second transmitter node to configure the second transmitter node to cooperate with the first transmitter node.

In an example of any of the preceding example aspects of the method, the first transmitter node and the second transmitter node may be configured to cooperate to transmit the plurality of packets to the intended receiver node over the plurality of MIMO layers in an initial transmission, and to transmit the set of cross-block check blocks to the intended receiver node over the plurality of MIMO layers in a retransmission.

In an example of any of the preceding example aspects of the method, the first transmitter node and the second transmitter node may be configured to cooperate to transmit the plurality of packets to the intended receiver node over a plurality of MIMO layers in an initial transmission, and to transmit the set of cross-block check blocks to the intended receiver node over a second plurality of MIMO layers in the same initial transmission.

In another example aspect, the present disclosure describes a method, at a transmitter node, the method including: obtaining a plurality of packets to be transmitted to an intended receiver node over a plurality of multiple-input multiple-output (MIMO) layers; for at least one packet to be transmitted over at least one MIMO layer, generating a set of one or more cross-block check blocks, the set of one or more cross-block check blocks being generated using a plurality of bits selected from across two or more code blocks of the at least one packet; and transmitting the set of one or more cross-block check blocks over a MIMO layer.

In an example of the preceding example aspect of the method, the method may include: transmitting the at least one packet over the at least one MIMO layer in an initial transmission, the at least one MIMO layer being a first subset of available MIMO layers at the transmitter node; where the set of one or more cross-block check blocks may be transmitted over a MIMO layer not included in the first subset, and the set of one or more cross-block check blocks may be transmitted with the at least one packet in the initial transmission.

In an example of the preceding example aspect of the method, the method may include: transmitting the at least one packet over the at least one MIMO layer in an initial transmission; and transmitting the set of one or more cross-block check blocks over the same at least one MIMO layer in a retransmission.

In an example of the preceding example aspect of the method, the method may include: receiving feedback, associated with the at least one MIMO layer, indicating the retransmission is required; where the retransmission may be performed in response to the received feedback.

In an example of a preceding example aspect of the method, the set of one or more cross-block check blocks may be transmitted in the retransmission in absence of any feedback.

In an example of any of the preceding example aspects of the method, the plurality of bits selected from across two or more code blocks of the at least one packet may be selected using a set of interleavers associated with a redundancy version (RV) index.

In an example of the preceding example aspect of the method, the method may include: generating the set of one or more cross-block check blocks includes generating a first set of one or more cross-block check blocks using a first plurality of bits selected across two or more code blocks of a first packet using a first set of interleavers associated with a first RV index, and generating a second set of one or more cross-block check blocks using a second plurality of bits selected across two or more code blocks of a second packet using a second set of interleavers associated with a second RV index; and transmitting the set of one or more cross-block check blocks includes transmitting the first set of one or more cross-block check blocks over a first MIMO layer, and transmitting the second set of one or more cross-block check blocks over a second MIMO layer in a same transmission.

In an example of any of the preceding example aspects of the method, a first packet of the plurality of packets may be mapped to a first MIMO layer using a first modulation and coding scheme (MCS) and a second packet of the plurality of packets may be mapped to a second MIMO layer using a second MCS different from the first MCS.

In another example aspect, the present disclosure describes a method, at a receiver node, the method including: receiving a plurality of packets over a plurality of multiple-input multiple-output (MIMO) layers; receiving a set of cross-block check blocks generated from a plurality of bits selected from across two or more of the plurality of packets received over respective two or more MIMO layers; and performing decoding of the plurality of packets using the set of cross-block check blocks to assist in decoding of the plurality of packets.

In an example of the preceding example aspect of the method, the plurality of packets may be received over the plurality of MIMO layers in an initial transmission, and the set of cross-block check blocks may be received over one or more MIMO layers, different from the plurality of MIMO layers, in the initial transmission.

In an example of any of the preceding example aspects of the method, the method may further include: after receiving the plurality of packets, attempting to decode the plurality of packets and transmitting feedback indicating decoding of the plurality of packets was unsuccessful; and receiving the set of cross-block check blocks in a retransmission after transmitting the feedback.

In an example of any of the preceding example aspects of the method, the plurality of packets may be received from two or more different transmitter nodes over the plurality of MIMO layers.

In an example of the preceding example aspect of the method, the set of cross-block check blocks may be received from at least one of the two or more different transmitter nodes.

In another aspect, the present disclosure describes a method, at a transmitter node, the method including: obtaining a packet to be transmitted to an intended receiver node over a plurality of multiple-input multiple-output (MIMO) layers; generating a set of one or more cross-block check blocks using a plurality of bits selected from across two or more code blocks of the packet; and transmitting the set of one or more cross-block check blocks over one or more MIMO layers.

In an example of the preceding example aspect of the method, the method may further include: transmitting the packet over the plurality of MIMO layers in an initial transmission, the plurality of MIMO layers being a first subset of available MIMO layers at the transmitter node; where the set of one or more cross-block check blocks may be transmitted over a MIMO layer not included in the first subset, and the set of one or more cross-block check blocks may be transmitted with the packet in the initial transmission.

In an example of a preceding example aspect of the method, the method may further include: transmitting the packet over the plurality of MIMO layers in an initial transmission; and transmitting the set of one or more cross-block check blocks over the one or more MIMO layers in a retransmission.

In an example of the preceding example aspect of the method, the method may further include: receiving feedback indicating decoding of the packet was unsuccessful; where the retransmission may be performed in response to the received feedback.

In an example of a preceding example aspect of the method, the set of one or more cross-block check blocks may be transmitted in the retransmission in absence of any feedback.

In an example of any of the preceding example aspects of the method, the plurality of bits selected from across two or more code blocks of the packet may be selected using a set of interleavers associated with a redundancy version (RV) index.

In another example aspect, the present disclosure describes an apparatus including: a processing unit; and a non-transitory memory including instructions that, when executed by the processing unit, cause the apparatus to perform any one of the preceding example aspects of the method.

In another example aspect, the present disclosure describes a computer readable medium having machine-executable instructions stored thereon, wherein the instructions, when executed by a processing unit of an apparatus, cause the apparatus to perform any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a schematic diagram of an example wireless communication system suitable for implementing examples described herein;

FIG. 2 is a block diagram showing an example apparatus suitable for implementing examples described herein;

FIG. 3A is a block diagram illustrating an example of how a packet may be transmitted over multiple MIMO layers;

FIG. 3B is a block diagram illustrating an example of how cross-block check blocks may be generated and transmitted over MIMO layers;

FIG. 4A illustrates an example code structure for a single transport block (TB) based on systematic code, including horizontal check blocks and cross-block check blocks;

FIG. 4B illustrates an example code structure for a single TB based on non-systematic code, including cross-block check blocks;

FIG. 5 illustrates an example code structure for multiple packets based on systematic code, including horizontal check blocks and cross-block check blocks;

FIG. 6A is a flowchart illustrating an example method for generating and transmitting cross-block check blocks over MIMO layers;

FIGS. 6B and 6C are block diagrams illustrating example implementations of the method of FIG. 6A;

FIG. 6D illustrates an example of how the cross-block check blocks of FIGS. 6B and 6C may be generated;

FIG. 7A is a flowchart illustrating another example method for generating and transmitting cross-block check blocks over MIMO layers;

FIG. 7B is a block diagram illustrating an example implementation of the method of FIG. 7A;

FIG. 7C illustrates an example of how the cross-block check blocks of FIG. 7B may be generated;

FIG. 8A is a flowchart illustrating another example method for generating and transmitting cross-block check blocks over MIMO layers;

FIG. 8B is a block diagram illustrating an example implementation of the method of FIG. 8A;

FIG. 9 is a block diagram illustrating an example of link adaptation in a MIMO retransmission scheme;

FIGS. 10A and 10B are block diagrams illustrating examples of multiple transmitter node cooperation in a MIMO retransmission scheme;

FIG. 11 is a flowchart illustrating an example method for multiple transmitter node cooperation; and

FIG. 12 is a flowchart illustrating an example method performed at a receiver node.

Similar reference numerals may have been used in different figures to denote similar components.

### DETAILED DESCRIPTION

To assist in understanding the present disclosure, an example wireless communication system is first described.

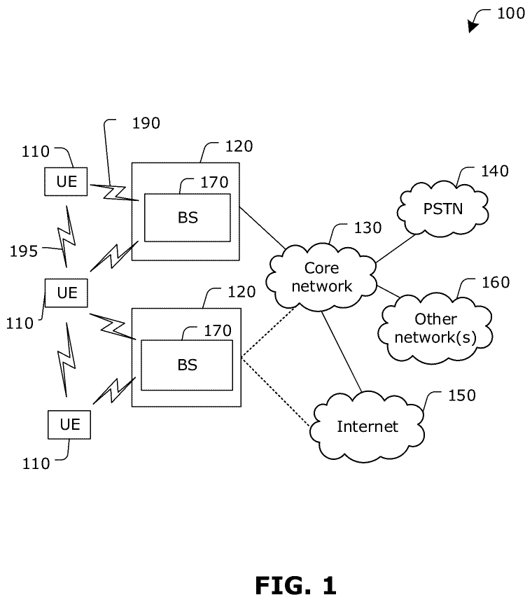

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, narrowcast, user device to user device, etc.) among entities of the system 100. The wireless system 100 may operate by sharing resources such as bandwidth. The wireless system 100 may be suitable for wireless communications using 5G technology and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home eNodeB, a gNodeB (gNB) (sometimes called a next-generation Node B), a transmission point (TP), a transmission and reception point (TRP), a site controller, an access point (AP), or a wireless router, among other possibilities. Future generation BSs 170 may be referred to using other terms. In some examples, the term TRP may be used to encompass a BS 170 or any other node that may serve to transmit and receive communications. Thus, although the present disclosure makes references to BSs 170, it should be understood that this is not intended to be limiting. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. The number of RANs 120 shown is exemplary only. Any number of RANs may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V21) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

In the present disclosure, the UEs 110 and the BSs 170 may communicate (e.g., over UL, DL or SL interfaces 190, 195) using multiple-input multiple-output (MIMO) technology (e.g., UEs 110 and BSs 170 may each have multiple transceiver antennas to support MIMO transmission/reception). MIMO technology may help to improve reliability of wireless transmission, for example by providing diversity gain or beamforming gain, or help to increase throughput using a spatial multiplexing scheme. When a spatial multiplexing scheme is used, transmissions may be over multiple transmission layers. A transmission layer refers to a datastream that is transmitted. In the case of MIMO transmissions, there are at least two transmission layers, or more generally L transmission layers (where L is at least two). The L transmission layers are mapped to N antenna streams (which are fed to respective transmission antennas (or antenna ports)) by means of a MIMO precoder matrix of size N×L. Generally, the number of transmission layers (i.e., L, also referred to as the transmission rank) is less than or equal to the number of antenna streams (i.e., N). In the present disclosure, there are at least two transmission layers for MIMO transmission, and the transmission layers may be referred to as MIMO layers.

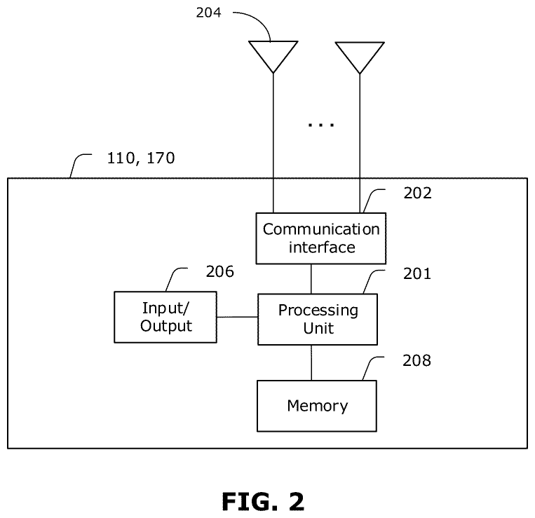

FIG. 2 illustrates an example apparatus that may implement examples disclosed herein. FIG. 2 illustrates a possible embodiment for the UE 110 and BS 170, and is not intended to be limiting.

As shown in FIG. 2, an example apparatus (e.g., an example embodiment of the UE 110 or BS 170) includes at least one processing unit 201. The processing unit 201 implements various processing operations of the apparatus. For example, the processing unit 201 could perform signal coding, data processing, power control, input/output processing, or any other functionality of the apparatus. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit.

The apparatus (e.g., the UE 110 or BS 170) includes at least one communication interface 202 for wired and/or wireless communications. One or multiple communication interfaces 202 could be used in the apparatus. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus (e.g., the UE 110 or BS 170) includes a plurality of antennas 204, to support MIMO communications. Each antenna 204 includes any suitable structure for transmitting and/or receiving wireless or wired signals. In some examples, there may be one or more antennas 204 used for transmitting signals and separate one or more antennas 204 used for receiving signals.

The apparatus (e.g., the UE 110 or BS 170) further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus (e.g., the UE 110 or BS 170) includes at least one memory 208. The memory 208 stores instructions and data used, generated, or collected by the apparatus. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

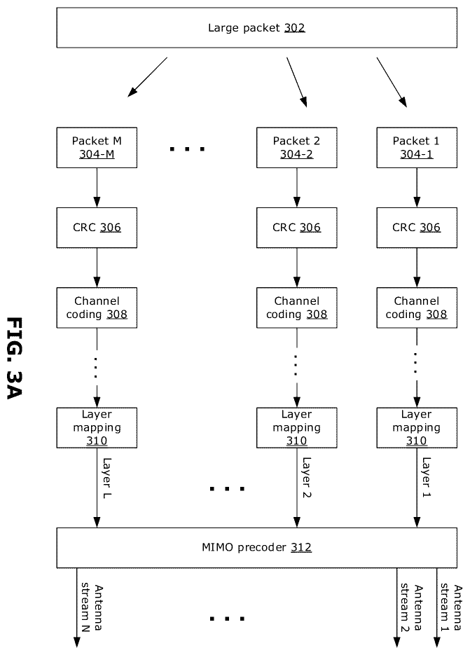

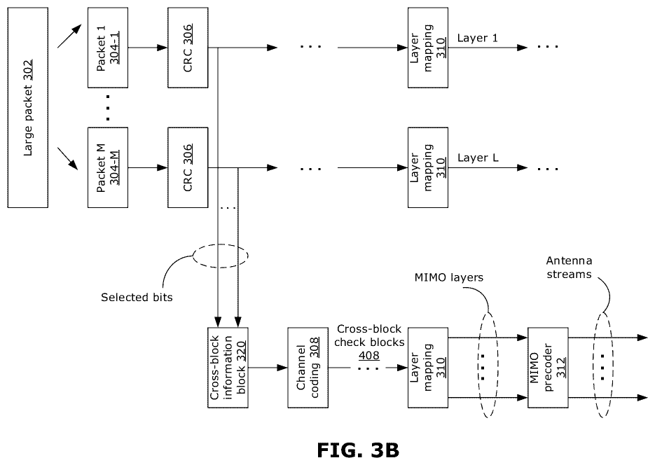

FIG. 3A illustrates an example of how a large packet (i.e., having large data size) may be transmitted over multiple MIMO layers. In particular, FIG. 3A illustrates example operations that may be implemented for an initial transmission of a large packet, for example using the processing unit 201 and the communication interface 202 of an apparatus (e.g., the UE 110 or BS 170) that is a transmitter node of a MIMO transmission.

A large packet 302 is obtained (e.g., internally generated or received from another network node) and is split into multiple packets of smaller size (i.e., smaller data size). In this example, the large packet 302 is split into M packets 304-1 to 304-M, generally referred to as packets 304. In some examples, a packet 304 may represent a transport block (TB) in the physical layer. Each packet 304 may be a single TB, for example. For each packet 304, a respective cyclic redundancy check (CRC) block is generated and appended to the packet 304 at CRC operation 306. The packet 304 with appended CRC block may be segmented into multiple code blocks (CBs) (not shown in FIG. 3A), or may be a single CB. In the initial transmission, the information bits of each CB are encoded using a suitable channel coding scheme 308, for example using any suitable forward error correction (FEC) code, such as low-density parity-check (LDPC) code. Other processing operations (e.g., rate matching, code block concatenation, scrambling and modulation) may be performed (not shown in FIG. 3A), for example to output a modulation symbol from a packet 304.

The packet 304 (after appropriate processing as described above) is mapped to one or more MIMO layers by a layer mapping operation 310. The layer mapping operation 310 may map a packet 304 to one or more MIMO layers based on predefined mapping rules (e.g., as defined in a standard), such as 1-to-1 mapping (i.e., one packet mapped to one MIMO layer) or 1-to-many mapping (i.e., one packet mapped to multiple MIMO layers). In the example shown, one packet 304 is mapped to one MIMO layer (such that the M packets 304 map to L MIMO layers, where L is equal to M). However, in other examples one packet 304 may be mapped to multiple MIMO layers, and different packets 304 may be mapped to different numbers of MIMO layers (such that the M packets 304 map to L MIMO layers, where L is greater than M). There may be different ways of mapping a packet 304 to multiple MIMO layers when the packet 304 contains multiple CBs. In one scenario, the multiple CBs belonging to a packet 304 may be mapped to multiple MIMO layers sequentially such that all the bits in one CB is selected to map to one of the MIMO layers before any bit in the next CB is selected. For example, if a packet 304 contains K CBs that are to be mapped to K MIMO layers, a first CB (denoted CB1) may be mapped to MIMO layer 1, a second CB (denoted CB2) may be mapped to MIMO layer 2, and so forth until the K-th CB (denoted CBK) may be mapped to MIMO layer K. In another example, if a packet 304 has 2 CBs that are to be mapped to 4 MIMO layers, then CB1 may be mapped to MIMO layers 1 and 2, while CB2 may be mapped to layer 3 and 4. In yet another example, if a packet 304 contains 4 CBs that are to be mapped to 2 MIMO layers, then CB1 and CB2 may be mapped to MIMO layer 1, and third and fourth CBs (denoted CB3 and CB4, respectively) may be mapped to MIMO layer 2. In another scenario, a packet 304 having multiple CBs may be mapped to multiple MIMO layers in a way such that the bits of all CBs are interleaved together before mapping to the MIMO layers, such that each CB is spread over all MIMO layers. For example, if the packet 304 contains 4 CBs that are to be mapped to 4 MIMO layers, the first MIMO layer may include a first bit of CB1, a first bit of CB2, a first bit of CB3 and a first bit of CB4, followed by a second bit of CB1, a second bit of CB2, a second bit of CB3, a second bit of CB4, and so forth. In this way, each MIMO layer may contain a quarter of the bits from each of CB1, CB2, CB3, and CB4. It should be understood that the above packet to MIMO layer mapping schemes may also be applicable to mapping of cross-block check blocks to MIMO layers. In general, it should be understood that there are various ways in which CBs (and cross-block check blocks, where applicable) may be mapped to MIMO layers, which are all within the scope of the present disclosure and which may be used in various examples described herein.

Each layer is a datastream, and the layers are processed by a MIMO precoder 312. The MIMO precoder serves to map the L MIMO layers to N antenna streams (where N is not necessarily equal to L), where each antenna stream may be further processed through time-frequency resource mapping as well as physical antenna mapping and is fed to a respective transmission antenna (or antenna port) for MIMO transmission.

In another example, it may not be the case that there are multiple packets 304 being transmitted over multiple MIMO layers. For example, a single packet 304 may be divided into multiple CBs and the multiple CBs may be transmitted over multiple MIMO layers.

At the receiver node, the MIMO transmission is received at a plurality of reception antennas. The receiver node performs suitable operations that attempt to demap the MIMO layers and decode the transmitted packets 304 (which may then be further processed to reassemble the original large packet 302). For example, the receiver node may perform time-frequency synchronization, demodulation, MIMO demapping, and decoding of the channel code, among other operations. Information contained in a check block (e.g., CRC block) may be used to assist in the decoding. If a decoding attempt is not successful, the receiver node may send feedback (e.g., a negative acknowledgment (NACK)) back to the transmitter node to indicate that the decoding attempt was not successful. The transmitter node may receive the feedback as an indication that a retransmission is required.

It should be understood that, although the present disclosure makes reference to a packet having CBs, this is not intended to be limiting. Throughout the various examples described herein, it may be understood that a packet may represent a TB in the physical layer, for example. In other examples, a packet may have a single CB. In yet other examples, a packet may have multiple CBs. All such variations may be possible in various examples described herein.

Hybrid automatic repeat request (HARQ) is a commonly used retransmission technique. Conventional HARQ retransmission schemes are typically TB based. If the receiver node was unsuccessful in decoding even one CB of a packet (where a packet may be a single TB), then negative feedback is sent back to the transmitter node and the transmitter node performs a retransmission of the entire packet, even if other CBs of the packet were successfully decoded by the receiver node. This may be an inefficient use of communication resources. In New Radio (NR) Release 15, code block group (CBG) based HARQ retransmission is supported. In CBG based HARQ retransmission, CBs are grouped in CBGs, and feedback from the receiver node includes the index of the CBG containing the CB that was not successfully decoded. Then the retransmission can be based on only the CBG having the index indicated in the feedback. However, CBG based HARQ retransmission requires the feedback to include the CBG index that needs to be retransmitted, which increases the overhead of the HARQ feedback. Further, in the case where each CGB has one (or more) CB in error, all CBGs (i.e., the entire TB) are used for the retransmission thus there would be no savings in retransmission, in addition to the added overhead of having to feedback the CBG indexes. As such, CBG based HARQ still may result in inefficiencies.

In the context of MIMO transmissions, conventional HARQ retransmission schemes may be MIMO layer agnostic, meaning that a retransmission may require all packets to be retransmitted over all MIMO layers, until all packets are successfully decoded. This may compound the problem of inefficiencies in retransmission using conventional TB or CBG based retransmission schemes. Further, in the context of ultra-reliable low-latency communication (URLLC) applications, such inefficient retransmissions may result in unacceptable delays.

In some examples, the present disclosure describes a MIMO-based HARQ retransmission scheme in which a retransmission is performed using check blocks generated from bits selected across different packets, where different packets can be transmitted over different MIMO layers. Such check blocks may be referred to herein as multi-layer (or cross-layer) cross-block check blocks, where multi-layer refers to the selection of bits from different packets that can be mapped to different MIMO layers, and cross-block refers to the selection of bits from different CBs (belonging to different packets). A HARQ retransmission scheme using multi-layer cross-block check blocks may be referred to as multi-layer 2D HARQ (where 2D refers to the check blocks being generated using bits selected from across different code blocks).

In some other examples, the present disclosure describes a MIMO-based HARQ retransmission scheme in which a retransmission is performed using check blocks generated from across different CBs of a packet mapped to a single MIMO layer. Such check blocks may be referred to here as single-layer cross-block check blocks, and a HARQ retransmission scheme using single-layer cross-block check blocks may be referred to as single-layer 2D HARQ (where 2D refers to the check blocks being generated using bits selected from across different CBs).

The term cross-block check block may thus encompass both multi-layer cross-block check blocks (or cross-layer check blocks) and single-layer cross-block check blocks. The term check block should be understood to encompass various techniques that may be used to combine bits selected from across different CBs, including using XOR or using a linear combination of bits (among other possibilities). Accordingly, the term check block may be generally understood to encompass coded bits that may be generated from the selected bits using any suitable techniques, and is not necessarily limited to encoding of the selected bits by a channel code for example.

FIG. 3B illustrates an example of how a set of cross-block check blocks may be generated and transmitted over MIMO layers, for example using the processing unit 201 and the communication interface 202 of an apparatus (e.g., the UE 110 or BS 170) that is a transmitter node of a MIMO transmission.

Similar to FIG. 3A, a large packet 302 is split into smaller packets 304, which are mapped to multiple MIMO layers for transmission. For simplicity, operations for processing the packets 304 to be transmitted over multiple MIMO layers are not shown in FIG. 3B.

Information bits are selected from across different packets 304 (which are later mapped to different MIMO layers), after the CRC generation 306. Specifically, one or more bits are selected from each of two or more different packets 304 (i.e., at least one bit is selected from each of the two or more different packets 304) and the group of selected bits may be referred to herein as a cross-block information block 320. It may be noted that mapping of different packets 304 to different MIMO layers may be configured for the apparatus, and the way in which the bits are selected from across the different packets 304 for the cross-block information block 320 may also be configured (e.g., semi-statically or dynamically configured). It should also be understood that the cross-block information block 320 may be formed using bits selected from fewer than all of the packets 304.

As previously mentioned, each packet 304 may correspond to a TB that can be further divided into one or multiple CBs. In an example, where each packet 304 corresponds to a single CB, the cross-block information block 320 may be formed using bits selected from each CB corresponding to each packet 304. In another example where a single packet 304 (or a single large packet 302 that is not divided into smaller packets 304) is divided into multiple CBs that are mapped to different MIMO layers, the cross-block information block 320 may be formed using bits selected from across the different CBs. Thus, the cross-block information block 320 may include bits selected from CBs that are transmitted across multiple MIMO layers but that originate from a single packet 304.

The cross-block information block 320 may then be processed by a suitable channel coding scheme 308 (e.g., using any suitable FEC code such as LDPC code) to generate a set of cross-block check blocks 408. As previously mentioned, other methods (e.g., using XOR or a linear combination) of combining the bits of the cross-block information block 320 to generate the cross-block check blocks 408 may be used. Other processing operations (e.g., rate matching, code block concatenation, scrambling and modulation) may be performed. The set of cross-block check block(s) 408 (after appropriate processing operations) is then mapped to one or more MIMO layers by the layer mapping operation 310, then processed by the MIMO precoder 312 into one or more antenna streams for transmission. The cross-block check blocks 408 thus contain information from across different packets 304 mapped to different MIMO layers, and can assist the receiver node in decoding packets 304 received over different MIMO layers.

As will be discussed further below, one or more cross-block check block(s) 408 may be transmitted together with the packets 304 in an initial transmission. Additionally or alternatively, one or more cross-block check block(s) 408 may be transmitted in a retransmission following an initial transmission of the packets 304.

In a similar procedure, a set of single-layer cross-block check block(s) may be generated by selecting information bits from across different CBs of one packet mapped to one MIMO layer. The single-layer cross-block check block(s) may then be mapped to the same MIMO layer as the source packet. The use of single-layer cross-block check block(s) may support layer-specific or layer-dependent HARQ feedback, as discussed further below.

Techniques for generating cross-packet check blocks or cross-block check blocks (also referred to as vertical check blocks (VCBs)), have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-packet check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020, the entirety of which is hereby incorporated by reference. It should be understood that techniques for generating cross-packet check blocks may be adapted to generate multi-layer cross-block check blocks or single-layer cross-block check blocks, as disclosed herein.

To assist in understanding the present disclosure, some example code structures are now described.

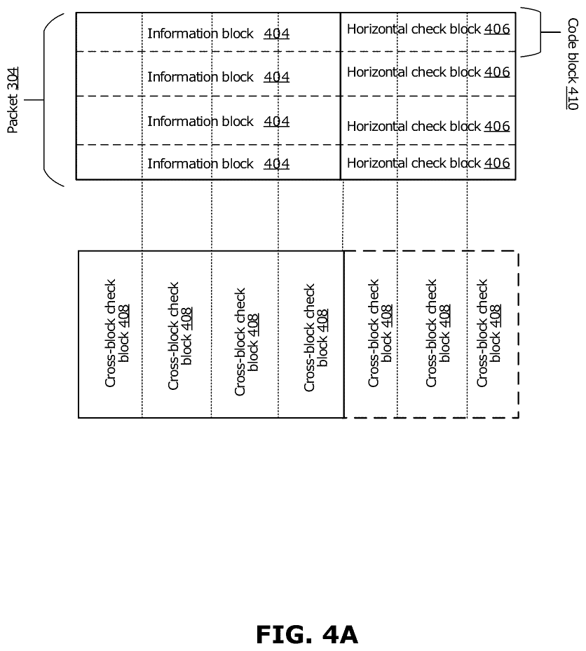

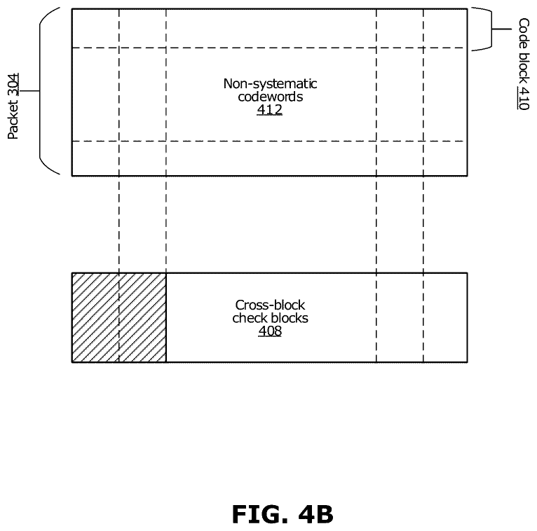

FIG. 4A illustrates an example code structure for a single packet 304 (which may be one TB) that is segmented into multiple CBs 410. The packet 304 includes multiple information blocks 404 formed from encoder input bits (in this example, four information blocks 404 are shown for simplicity, however this is not intended to be limiting). The information block may include a CRC block that is appended to the data for checking whether the code block 410 is decoded successfully. The encoder input bits may also be referred to as information bits. The bits in this example are arranged in rows and columns. The code structure includes check blocks that are each generated using bits from a single information block 404; such check blocks may be referred to as horizontal check blocks 406 (in this example, one horizontal check block 406 for each information block 404). For example, each horizontal check block 406 may be generated by applying a channel coding scheme (e.g. a LDPC code) to encode the information block 404.

Cross-block check blocks 408 are generated using bits selected from across two or more CBs 410. In some examples, cross-block check blocks 408 may be referred to as vertical check blocks (to distinguish from the horizontal check blocks 406). However, it should be understood that the terms “vertical” and “horizontal” are not intended to imply any physical structure or orientation and are not intended to be limiting; for example, the descriptors “horizontal” and “vertical” may be equally replaced with “first” and “second”, respectively. It should be understood that the terms “parity block” or “redundancy block” may also be used instead of “check block”.

In this example, one or more cross-block check blocks 408 are generated using bits selected from across multiple information blocks 404. Optionally, one or more cross-block check blocks 408 may also be generated using bits selected from across multiple horizontal check blocks 406. Cross-block check blocks 408 generated from bits selected from horizontal check blocks may be referred to as “check on check” blocks.

The number of cross-block check blocks 408 to be used (including whether check on check blocks are used) may be based on configuration at the transmitter node (e.g., the BS 170 for downlink DL transmissions, or the UE 110 for uplink UL transmissions or SL transmissions) and/or defined by a standard.

In the example of FIG. 4A, the CBs 410 are systematic CBs in that they each include systematic bits (in the information block 404) and check bits (in the horizontal check block 406) determined from the systematic bits. In other examples (discussed further below), the CBs 410 may be non-systematic.

Each cross-block check block 408 is generated from bits selected across multiple CBs 410. In particular, one or more bits may be selected from each CB 410. The selected bits may be referred to as cross-block bits (because the bits are selected from across multiple CBs 410), and the group of selected bits may be referred to as the cross-block information block. When CBs 410 are arranged in rows, as shown in FIG. 4A, each cross-block check block 408 may be generated from a column of bits, where the column of bits may have any suitable width (e.g., may be one or more bits wide). Different cross-block check blocks 408 may be generated from columns of different bit widths (i.e., different cross-block check blocks 408 may be generated using different numbers of cross-block bits). In some examples, each CB 410 may be divided into equal (or approximately equal) number of bits, referred to as subblocks. Then each cross-block check block 408 may be generated from bits belonging to a respective column of subblocks. The cross-block information block (formed from the selected cross-block bits) is then encoded (e.g., using a FEC code, such as LDPC code) or otherwise combined (e.g., using XOR, linear combination, etc.) to obtain the cross-block check block 408.

FIG. 4A shows, and has been described with, bits being arranged in rows and columns; for example the cross-block check block 408 is shown as having a rectangular/two dimensional structure. However, this is only for the purpose of illustration and is not intended to limit how the bits are arranged logically or in transmission. Further, the code structure shown in FIG. 4A may be divided up for transmission. Typically all the bits of one cross-block check block 408 are transmitted in the same transmission opportunity.

The check bits contained in the horizontal check blocks 406 and cross-block check blocks 408 are useful to assist decoding at a receiver node. For example, after each decoding attempt at a decoder, error checking can be performed using CRC bits to determine if the information bits in the CB 410 have been successfully decoded. The cross-block check block 408 contains check bits determined from across multiple CBs 410, and thus provides information useful for decoding multiple CBs 410. The decoder may use the check bits of the cross-block check block 408 to assist in decoding of a CB 410.

FIG. 4B illustrates an example code structure for a single packet 304 based on non-systematic code (e.g., Polar code, block code, or convolutional code). Each non-systematic codeword is determined based on a set of encoder input bits, but the information bits do not appear in the codeword as systematic bits. Unlike systematic codes, horizontal check bits cannot be simply appended at the end of each row.

The packet 304 includes multiple non-systematic codewords 412, each of which may be viewed as a CB 410. Unlike the example of FIG. 4A, the CB 410 does not include a distinct horizontal check block. Each cross-block check block 408 is generated by one or more of bits selected from across multiple CBs 410, similar to that described for FIG. 4A.

It will be appreciated by persons skilled in the art that the present disclosure is not dependent on whether systematic or non-systematic code is used. For simplicity, the following discussion may be based packets 304 having systematic CBs 410. It should be understood that this is not intended to be limiting.

In some examples, cross-block check blocks 408 may be generated from bits selected from across the CBs 410 of two or more packets 304. In MIMO applications, different packets 304 may be mapped to different MIMO layers. Cross-block check blocks 408 that are generated from bits selected from packets 304 mapped to different MIMO layers may be referred to as multi-layer cross-block check blocks 408, as mentioned previously.

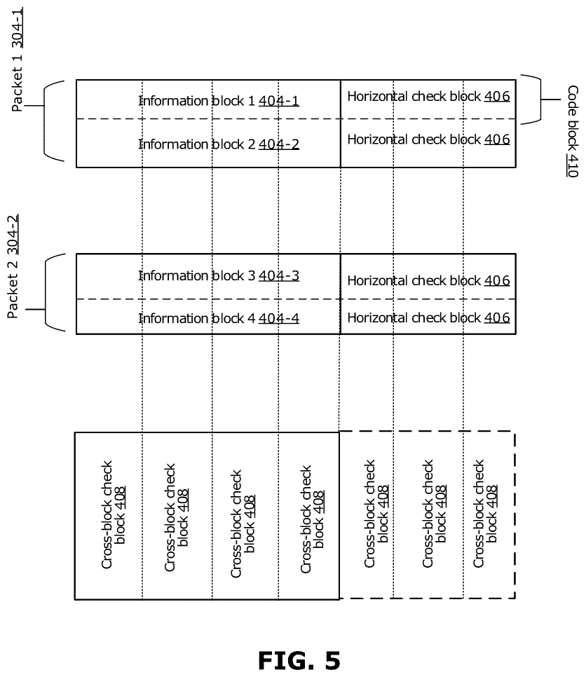

FIG. 5 illustrates an example in which cross-block check blocks 408 are generated using bits selected from across multiple packets 304. In this example, packet 1 304-1 and packet 2 304-2 (generally referred to as packets 304) are shown, however the cross-block check blocks 408 may be generated using bits selected from more than two different packets 304.

The multiple packets 304 may originate from one or more sources (e.g., two or more transmitter nodes, such as two or more TRPs, may cooperate with each other to jointly transmit the packets 304 and/or the generated cross-block check blocks 408 to an intended receiver node). In this example, the packets 304 use systemic code, and each packet 304 includes multiple CBs 410, however this is not intended to be limiting. Packet 1 304-1 includes information block 1 404-1 and information block 2 404-2, with respective horizontal check blocks 406 appended. Similarly, packet 2 304-2 includes information block 3 404-3 and information block 4 404-4, with respective horizontal check blocks 406 appended. It should be noted that the number of CBs 410 in each packet 304 is not necessarily equal.

To generate each cross-block vertical check block 408, one or more bits are selected from each packet 304 (e.g., one or more bits selected from packet 1 304-1 and one or more bits selected from packet 2 304-2). For example, to generate a cross-block vertical check block 408 one or more bits may be selected from each CB 410 of each packet 304. The selected bits may be referred to as cross-block bits (or cross-packet bits or cross-layer bits) that together form the cross-block information block.

As illustrated in FIG. 3B, for example, the cross-block bits may be selected from across multiple packets 304, following generation of the CRC block at 306 and prior to other processing such as channel coding. Notably, the different packets 304 are mapped to different MIMO layers. Thus, the cross-block information block 320 contains information relevant to packets transmitted over different MIMO layers. The bits of the cross-block information block 320 are encoded (e.g., using FEC code, such as LDPC code) or otherwise combined (e.g., using XOR, linear combination, etc.) to obtain the set of cross-block check blocks 408. In this way, a set of one or more cross-block check blocks 408 may be generated using bits selected from across multiple packets 304 that are mapped to multiple MIMO layers.

Regardless of the specific code structure (e.g., as illustrated in FIG. 4A, 4B or 5), each cross-block check block 408 is generated from bits selected from across multiple CBs 410. If the CBs 410 are arranged in horizontal rows in the code structure (e.g., as illustrated in FIG. 4A, 4B or 5), the cross-block check blocks 408 may be generated by selecting vertical columns of bits, where each column of bits contains bits from across the multiple rows of CBs 410. A set of cross-block check blocks 408 may be generated based on the bits of the CBs 410 in their natural order. The natural order of the bits may refer to the order of bits in each CB 410 as outputted by the encoder. A different set of cross-block check blocks 408 may be generated by shuffling (or interleaving) the bits within each CB 410 (such that the vertical columns of bits that are obtained after the shuffling or interleaving is different from the vertical columns of bits that are obtained when the bits of the CBs 410 are in their natural order). A predefined shuffling scheme or predefined interleaver may be used to perform this shuffling or interleaver. An interleaver may be a predefined algorithm or predefined matrix (among other possibilities) that is applied to the row of bits to obtain a reordered row of bits. It should be understood that other techniques (not necessarily limited to interleaving) may be used. Different sets of cross-block check blocks 408 may be thus generated for the same set of CBs 410, using the bits in their natural order or using different interleavers (e.g., where a different interleaver is associated with each different redundancy version (RV) index).

The CBs 410 may be transmitted in an initial transmission (which may be identified using the RV index RV0). One or more cross-block check blocks 408 (which may be generated using an interleaver associated with a specific RV index other than RV0) may be transmitted with the CBs 410 in the initial transmission and/or may be transmitted in a retransmission. In examples where the information CBs are systematic (such as LDPC code or Turbo code), an iterative decoding process may be used at the decoder (at the receiver node) to decode the received CBs. The decoder calculates log-likelihood ratios (LLRs) of bit values during decoding of the information CBs, which may be considered a “soft” output of the decoder. In the present disclosure, soft output may refer to decoder output that is not yet finalized (e.g., bit value not yet definitively determined to be 1 or 0 value) but may provide information that can still be useful (e.g., in a subsequent decoding iteration). Such soft output may be probabilistic in nature (e.g., LLR). CBs that are not correctly decoded (e.g., fails a check using the corresponding horizontal check blocks) may benefit from information encoded in the cross-block check blocks 408. Because each of the cross-block check blocks 408 is generated from information bits selected from two or more (or all) of the CBs 410, soft output from attempts to decode a cross-block check block 408 may help to improve decoding of the CBs 410 (and vice versa). In at least this way, cross-block check blocks 408 help to improve decoding.

In various examples, the present disclosure describes examples of how cross-block check blocks 408 may be generated from packets transmitted over one or more MIMO layers, and how such cross-block check blocks 408 may be transmitted. The present disclosure describes examples that may be implemented in the context of single transmitter node (or single TRP) transmission schemes, as well as examples that may be implemented in the context of multiple transmitter nodes cooperating with each other (e.g., multiple TRP transmission schemes). The present disclosure also describes examples that may support the use of link adaptation (e.g., using different modulation and coding schemes (MCS) for transmission on different MIMO layers).

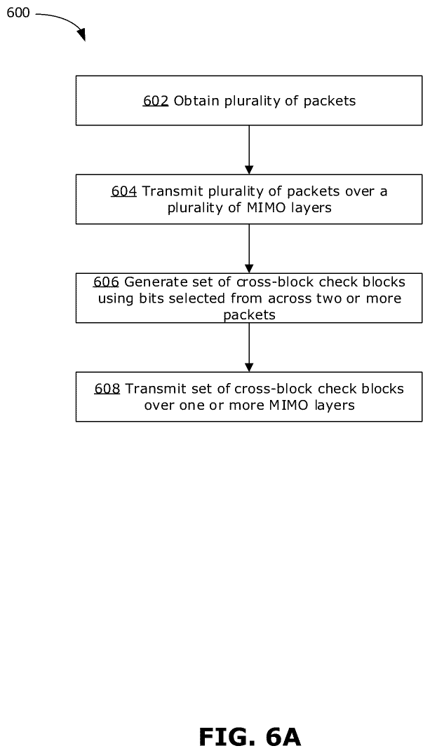

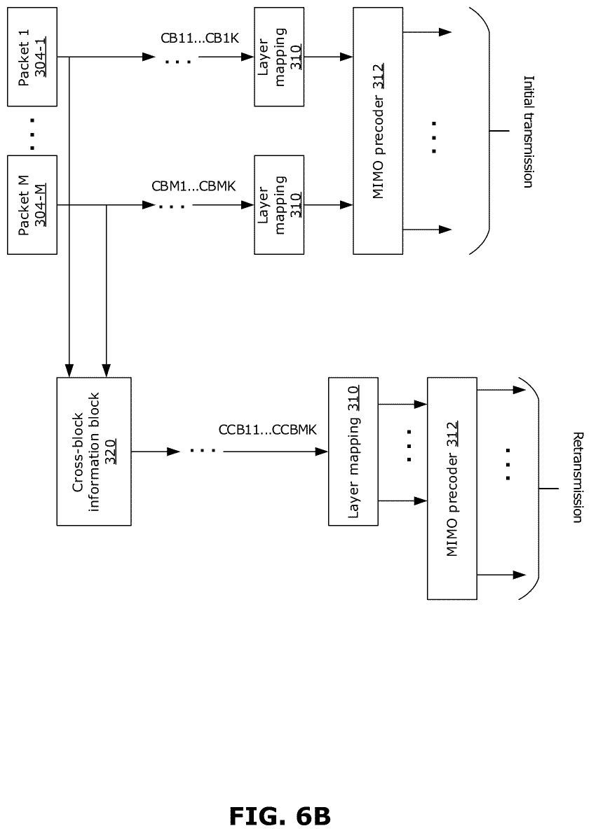

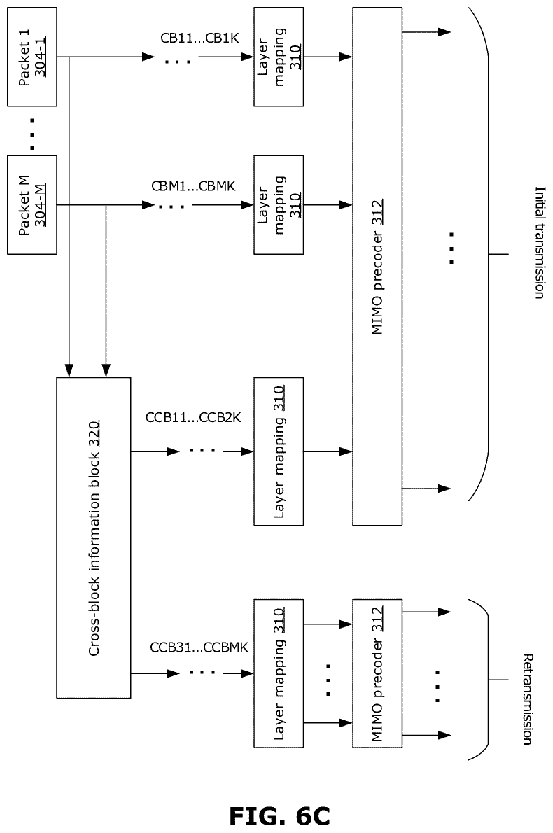

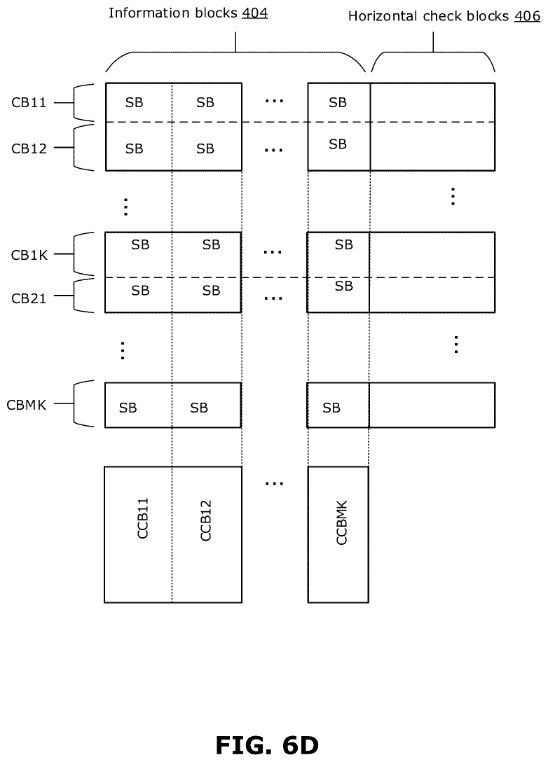

Reference is now made to FIGS. 6A and 6B. FIG. 6B illustrates an example in the context of a single transmitter MIMO transmission, where a set of cross-block check blocks 408 is generated from bits selected from across a plurality of packets 304. For simplicity, FIG. 6B omits the operations for processing the packets 304 up until the layer mapping operation 310, and similarly omits the operations for generating the cross-block check blocks 408 from the cross-block information block 320 up until the layer mapping operation 310. FIG. 6A is a flowchart illustrating an example method 600 that may be performed by the transmitter node for transmitting packets over a plurality of MIMO layers and for generating and transmitting cross-block check blocks over a plurality of MIMO layers, as illustrated in FIG. 6B. FIGS. 6A and 6B will be discussed together.

A set of cross-block check blocks (denoted as CCB in the figures) is generated using bits selected from different packets 304 (e.g., packet 1 304-1 to packet M 304-M) that are mapped to different MIMO layers. In this example, the packets 304 are transmitted in an initial transmission (which may have a RV index indicated as RV0) and the set of cross-block check blocks is transmitted in a retransmission (which may have a RV index that is any RV number other than RV0).

At 602, a plurality of packets 304 (e.g., packet 1 304-1 to packet M 304-M) are obtained. For example, the packets 304 may be generated internally by the transmitter node. Each packet 304 is processed into one or more CBs. FIG. 6B shows each packet 304 being processed into K CBs (e.g., packet 1 304-1 is processed into CB11 to CB1K), however this is not intended to be limiting. In some examples, there may be different numbers of CBs for different packets 304. As previously mentioned, in some examples a packet 304 may be a single TB, which may contain one or more CBs.

At 604, the packets 304 are transmitted over a plurality of MIMO layers. The CB(s) of each of packet 1 304-1 to packet M 304-M may be mapped, by a layer mapping operation 310, to one or more MIMO layers (i.e., the CBs of packet 1 304-1 may be mapped to a group of one or more MIMO layers, and the CBs of packet M 304-M may be mapped to a different group of one or more MIMO layers). The layers are then processed by the MIMO precoder 312 and transmitted in an initial transmission. It may be noted that the number of packets 304 (which may be split from a larger packet, as shown in FIG. 3A) should be equal to or smaller than the rank of MIMO layers that are available for MIMO transmission.

As will be discussed further below, in some examples the packets 304 may be transmitted with one or more cross-block check blocks in the initial transmission.

At 606, a set of cross-block check blocks is generated using bits selected from across two or more of the packets 304. In the example shown in FIG. 6B, bits are sampled from the CBs of each of packet 1 304-1 to packet M 304-M to form the cross-block information block 320. The cross-block information block 320 is encoded to generate a set of cross-block check blocks. FIG. 6B shows the set of cross-block check blocks having M×K cross-block check blocks (e.g., CCB11 to CCBMK). That is, the number of cross-block check blocks that are generated correspond to the number of CBs from all M packets 304. However, this is not intended to be limiting. In some examples, the number of cross-block check blocks generated may be larger or smaller than the number of source CBs.

FIG. 6D illustrates an example of how the cross-block check blocks CCB11 to CCBMK may be generated by sampling bits from across the CBs of each of the packets 304-1 to 304-M. In this example, the cross-block check blocks are not generated from the check bits of the horizontal check blocks 406, however in other examples there may be one or more cross-block check blocks generated from bits selected across the horizontal check blocks 406. As shown in FIG. 6D, the information block 404 of each CB may be divided into subblocks (SB), and each cross-block check block may be generated by taking a column of subblocks across all the CBs.

At 608, the set of cross-block check blocks is transmitted over one or more MIMO layers. For example, the CCB11 to CCBMK may be mapped, by a layer mapping operation 310, to one or more MIMO layers. The layers are then processed by the MIMO precoder 312 and may be transmitted in a retransmission. The retransmission may have any RV index number (e.g., the RV index may be associated with and indicative of the interleaver used to generate the cross-block check blocks), however RV0 may be reserved for the initial transmission.

In some examples, at 608, one or more of the generated cross-block check blocks may be transmitted over a MIMO layer in the initial transmission. This may be the case if there are one or more MIMO layers remaining available after the packets 304 have been mapped to the MIMO layers. For example, based on the packet size that each MIMO layer can support, there may be one or more MIMO unused layers in the initial transmission (i.e., one or more MIMO layers that are not being used to transmit a packet 304 in the initial transmission). Some or all of the generated cross-block check blocks may be transmitted using the MIMO layer(s) that remain unused after the packets 304 have been mapped, such that some or all of the generated cross-block check blocks may be transmitted in the initial transmission.

FIG. 6C illustrates an example in which some of the cross-block check blocks are transmitted in the initial transmission. For example, after the CBs of packet 1 304-1 to packet M 304-M have been mapped to a plurality of MIMO layers, at least one MIMO layer remains available. Thus, cross-block check blocks CCB11 to CCB2K can be transmitted over the at least one available MIMO layer and included in the initial transmission. The remaining cross-block check blocks CCB31 to CCBMK may be transmitted in a retransmission.

Notably, the cross-block check blocks CCB11 to CCBMK may be generated together (e.g., in a manner similar to that shown in FIG. 6D), but may be transmitted in separate transmission opportunities. Further, it may be noted that transmission of the source packets 304 may be associated with RV index RV0, and transmission of the cross-block check blocks CCB11 to CCBMK may be associated with RV index RV1 (e.g., to indicate the cross-block check blocks CCB11 to CCBMK were generated using the interleaver associated with RV1). Thus, the initial transmission uses different RV indexes over different MIMO layers. In a similar way, in a second retransmission (not shown), two sets of cross-block check blocks generated using different interleavers (associated with different RV indexes) may be transmitted over different MIMO layers. Use of different RV indexes in the same transmission opportunity may help to improve the decoding performance at the receiver node.

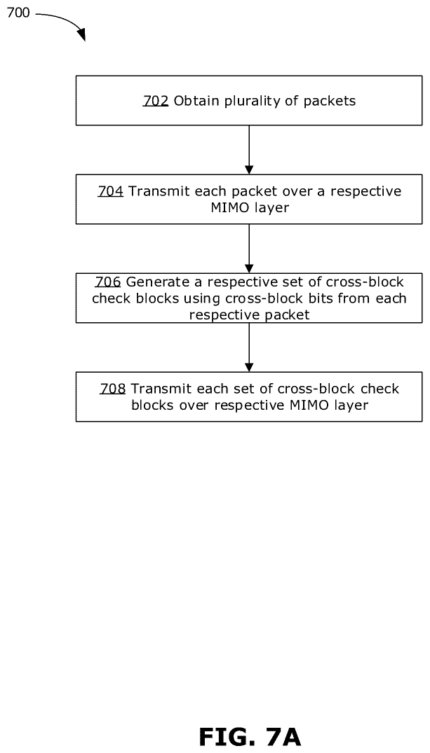

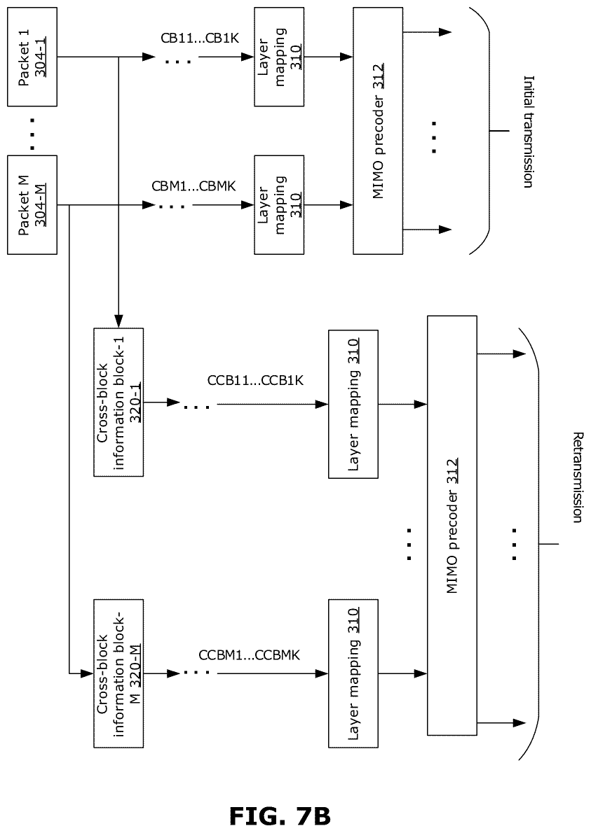

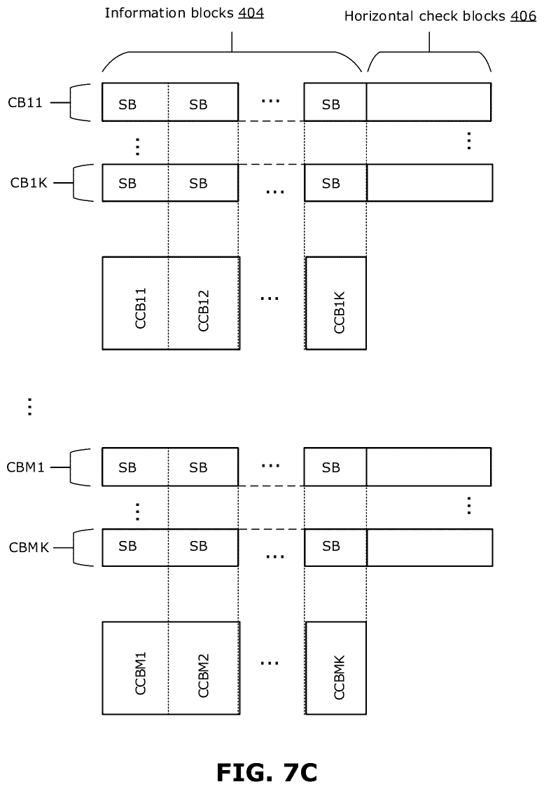

Reference is now made to FIGS. 7A and 7B. FIG. 7B illustrates an example in the context of a single transmitter MIMO transmission, where each set of cross-block check blocks 408 is generated from the CBs of a respective packet 304 that is transmitted over one respective MIMO layer (rather than across multiple packets 304 transmitted over multiple MIMO layers). Similar to FIG. 6B, FIG. 7B omits some operations for ease of understanding. FIG. 7A is a flowchart illustrating an example method 700 that may be performed by the transmitter node for transmitting packets over MIMO layers and for generating and transmitting cross-block check blocks over MIMO layers, as illustrated in FIG. 7B. FIGS. 7A and 7B will be discussed together.

In this example, the packets 304 are transmitted in an initial transmission (which may have a RV index indicated as RV0) and the sets of cross-block check blocks are transmitted in a retransmission (which may have a RV index that is other than RV0).

At 702, a plurality of packets 304 (e.g., packet 1 304-1 to packet M 304-M) are obtained. For example, the packets 304 may be generated internally by the transmitter node or received from another network node. Each packet 304 is processed into one or more CBs. FIG. 7B shows each packet 304 being processed into K CBs (e.g., packet 1 304-1 is processed into CB11 to CB1K), however this is not intended to be limiting. In some examples, there may be different numbers of CBs for different packets 304. As previously mentioned, in some examples a packet 304 may be a single TB, which may contain one or more CBs.

At 704, each packet 304 is transmitted over a respective MIMO layer. The CBs of each of packet 1 304-1 to packet M 304-M may be mapped, by a layer mapping operation 310, to a respective MIMO layer. In particular, a 1-to-1 mapping may be used such that the CBs of one packet 304 are all transmitted over one MIMO layer (i.e., the CBs of packet 1 304-1 may be mapped to MIMO layer 1, and the CBs of packet M 304-M may be mapped to MIMO layer M). The layers are then processed by the MIMO precoder 312 and transmitted in an initial transmission. It may be noted that the number of packets 304 (which may be split from a larger packet, as shown in FIG. 3A) should be equal to or smaller than the rank of MIMO layers that are available for MIMO transmission.

At 706, a set of cross-block check blocks is generated for each respective packet 304, using cross-block bits selected from the CBs of the respective packet 304. In the example shown in FIG. 7B, bits are sampled from the CBs of packet 1 304-1 to form the cross-block information block-1 320-1, which is used to generate CCB11 to CCB1K (i.e., a set of K cross-block check blocks for packet 1 304-1). Similarly, bits are sampled from the CBs of packet M 304-M to form the cross-block information block-M 320-M, which is used to generate CCBM1 to CCBMK (i.e., a set of K cross-block check blocks for packet M 304-M). Thus, M sets of cross-block check blocks are generated for M packets 304-1 to 304-M, where each set of cross-block check blocks contains K cross-block check blocks. FIG. 7B shows each set of cross-block check blocks having K cross-block check blocks, however this is not intended to be limiting. Each set of cross-block check blocks may independently have any number of one or more cross-block check blocks.

FIG. 7C illustrates an example of how each of the M sets of cross-block check blocks may be generated by sampling bits from across the CBs of the respective packet 304-1 to 304-M. In this example, the cross-block check blocks are not generated from the check bits of the horizontal check blocks 406, however in other examples there may be one or more cross-block check blocks generated from bits selected across the horizontal check blocks 406. As shown in FIG. 7C a first set of cross-block check blocks CCB11 to CCB1K may be generated by sampling bits across CB11 to CB1K belonging to packet 1 304-1. A similar procedure may be performed to generate a respective set of cross-block check blocks for each packet. For example, the M-th set of cross-block check blocks CCBM1 to CCBMK may be generated by sampling bits across CBM1 to CBMK belonging to packet M 304-M.

At 708, each set of cross-block check blocks is transmitted over a respective MIMO layer. In particular, a set of cross-block check blocks that is generated from a particular packet 304 is transmitted over the MIMO layer that was mapped to that particular packet 304. For example, the set of cross-block check blocks CCB11 to CCB1K is generated from the CBs of packet 1 304-1. Accordingly, if the CBs of packet 1 304-1 are transmitted over MIMO layer 1 in the initial transmission, CCB11 to CCB1K are also transmitted over MIMO layer 1 in a retransmission. The retransmission may have any RV index number, however RV0 may be reserved for the initial transmission.

In some examples, one packet 304 may be mapped to a group of one or more MIMO layers (i.e., not necessarily a single MIMO layer). In such a case, the set of cross-block check blocks generated from a particular packet 304 is transmitted over the same group of one or more MIMO layers as those used for the particular packet 304.

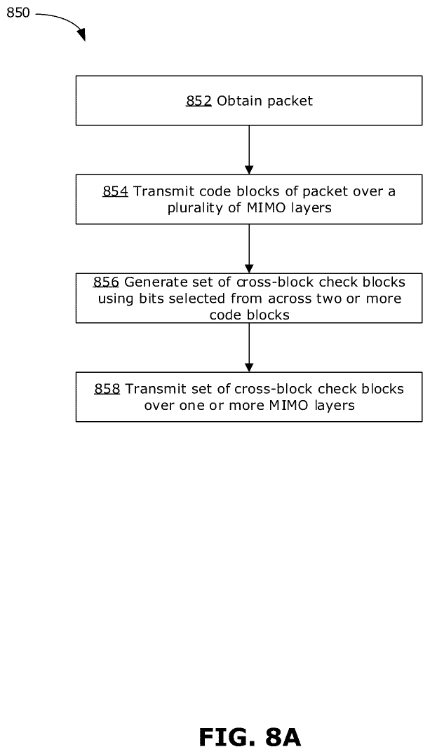

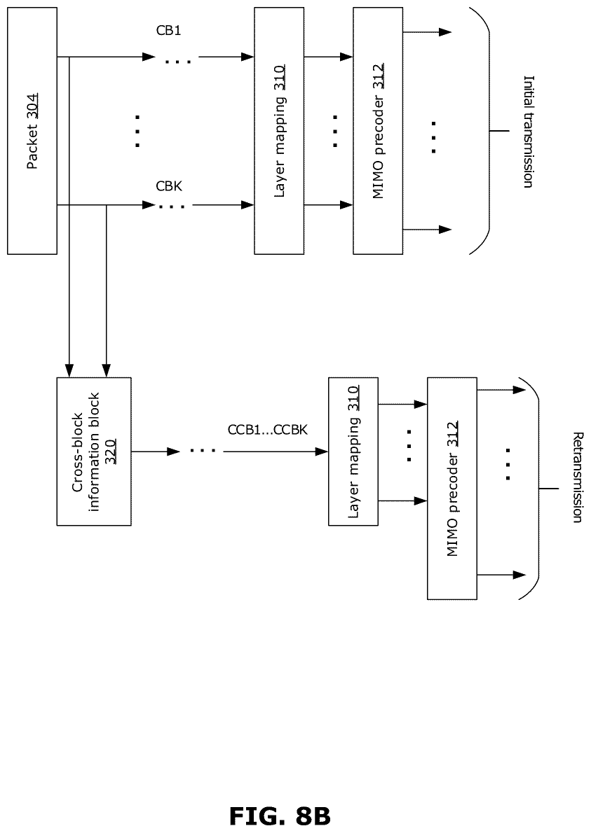

Reference is now made to FIGS. 8A and 8B. FIG. 8B illustrates an example in the context of a single transmitter MIMO transmission, where a set of cross-block check blocks 408 is generated from the CBs belonging to a single packet 304, where multiple MIMO layers are used for the transmission and retransmission(s). Similar to FIGS. 6B and 7B, FIG. 8B omits some operations for ease of understanding. FIG. 8A is a flowchart illustrating an example method 850 that may be performed by the transmitter node for transmitting the CBs of the single packet over multiple MIMO layers and for generating and transmitting cross-block check blocks, as illustrated in FIG. 8B. FIGS. 8A and 8B will be discussed together.

In this example, a packet 304 (e.g., corresponding to a single TB) is transmitted in an initial transmission (which may have a RV index indicated as RV0) and the set of cross-block check blocks is transmitted in a retransmission (which may have a RV index that is other than RV0). The packet 304 may, in some examples, be a single large packet 302 that is not divided into smaller packets 304. As previously mentioned, the packet 304 (or the large packet 302) may correspond to a single TB.

At 852, a packet 304 is obtained. For example, the packet 304 may be generated internally by the transmitter node or received from another network node. The packet 304 is processed into a plurality of CBs. FIG. 8B shows the packet 304 being processed into K CBs, namely CB1 to CBK, however this is not intended to be limiting.

At 854, the CBs of the packet 304 are transmitted over a plurality of MIMO layers. The CBs may be mapped, by a layer mapping operation 310, to a respective MIMO layer. For example, a 1-to-1 mapping may be used such that each of CB1 to CBK is transmitted over one respective MIMO layer (i.e., the K CBs are transmitted over respective K MIMO layers). In other examples, a 1-to-many or many-to-1 mapping may be used. In another example, the packet 304 having multiple CBs may be mapped to multiple MIMO layers in a way such that the bits of all CBs are interleaved together before mapping to the MIMO layers and each CB is thus spread over all MIMO layers. Further, there may be different numbers of CBs mapped to different MIMO layers (e.g., where link adaptation is used, as described further below). The layers are then processed by the MIMO precoder 312 and transmitted in an initial transmission. It should be understood that any other methods to map a packet 304 with multiple CBs to the MIMO layers (including the various mapping methods described previously with respect to the example of FIG. 3A) can also be applied here. Regardless of how the CBs are mapped to MIMO layers, the result is that the CBs, which all originate from the same packet 304, are transmitted using a plurality of MIMO layers.

At 856, a set of cross-block check blocks is generated using cross-block bits selected from across two or more of the CBs of the packet 304. In the example shown in FIG. 8B, bits are sampled from each of CB1 to CBK, to generate a set of K cross-block check blocks CCB1 to CCBK. Thus, the set of cross-block check blocks is generated by sampling bits from across CBs that are transmitted over different MIMO layers, where the CBs may originate from the same packet 304. FIG. 8B shows the example where K cross-block check blocks are generated, however this is not intended to be limiting. The number of cross-block check blocks generated may or may not be equal to the number of CBs. The manner in which cross-block bits are selected from across the CBs may be similar to that shown in FIG. 6D, with the difference that the CBs may all belong to the same packet 304 (instead of M different packets 304).

At 858, the set of cross-block check blocks is transmitted over one or more MIMO layers. For example, CCB1 to CCBK may be mapped, by a layer mapping operation 310, to one or more MIMO layers. The layers are then processed by the MIMO precoder 312 and may be transmitted in a retransmission. The retransmission may have any RV index number (e.g., the RV index may be associated with and indicative of the interleaver used to generate the cross-block check blocks), however RV0 may be reserved for the initial transmission.

In some examples, at 858, one or more of the generated cross-block check blocks may be transmitted over a MIMO layer in the initial transmission. This may be the case if there are one or more MIMO layers remaining available after CB1 to CBK have been mapped to the MIMO layers. The MIMO layer(s) that remain unused after the K CBs have been mapped may be used to transmit one or more of the generated cross-block check blocks, such that one or more of the generated cross-block check blocks may be transmitted in the initial transmission (however the RV index associated with the MIMO layer(s) transmitting the cross-block check block(s) would not be RV0 but would be the RV index associated with the interleaver used to generate the cross-block check blocks).

Regardless of whether the method 600, the method 700 or the method 850 is performed, examples of the present disclosure may enable layer dependent link adaptation. When layer dependent link adaptation is used, each MIMO layer may independently support different MCS.

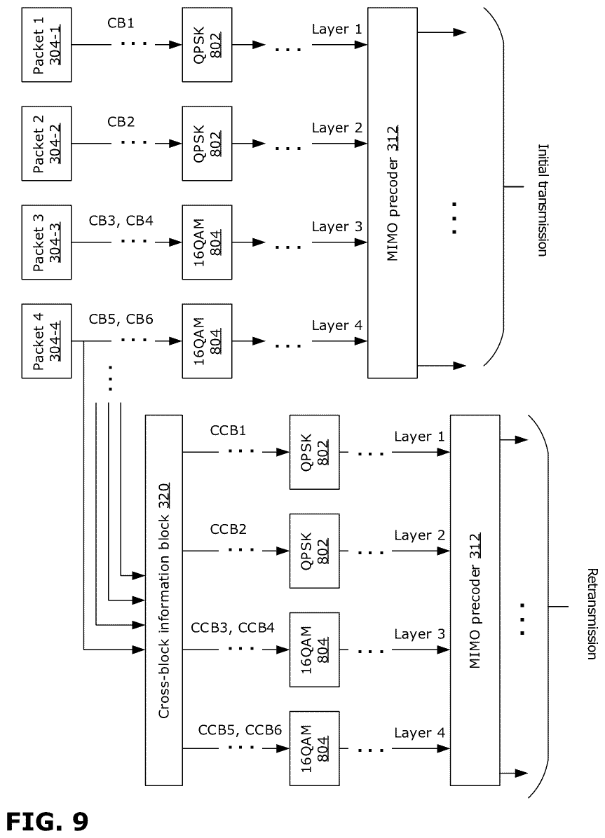

FIG. 9 illustrates a simple example of layer dependent link adaptation, in which cross-block check blocks are generated from bits selected from across multiple packets that are mapped to multiple different MIMO layers (although other mapping operations may also be used, such as 1-to-1 mapping). For simplicity, FIG. 9 illustrates four MIMO layers, however this is not intended to be limiting.

In this example, MIMO layers 1 and 2 support quadrature phase shift keying (QPSK) modulation 802 and MIMO layers 3 and 4 support 16-point quadrature amplitude modulation (16QAM) 804. Different MIMO layers may also support different code rate (not shown in FIG. 9). Because 16QAM enables a higher data rate than QPSK, MIMO layers 3 and 4 can accommodate a larger packet (and thus more CBs).

Thus, packet 3 304-3 and packet 4 304-4 (which are mapped to MIMO layers 3 and 4) can be larger than packet 1 304-1 and packet 2 304-2 (which are mapped to MIMO layers 1 and 2). As shown in FIG. 9, packet 1 304-1 and packet 2 304-2 are each processed into one CB (namely CB1 and CB2, respectively), whereas packet 3 304-3 and packet 4 304-4 are each processed into two CBs (CB3, CB4 for packet 3 304-3; CB5, CB6 for packet 4 304-4). The packets 304 are transmitted over the four MIMO layers in the initial transmission.

Bits are selected from across the four packets 304 to form the cross-block information block 320, which is then used to generate the set of cross-block check blocks CCB1 to CCB6. The layer mapping operation (not shown) is performed such that more cross-block check blocks are mapped to those MIMO layers that can support a higher data rate. In this example, CCB1 is mapped to MIMO layer 1 and CCB2 is mapped to MIMO layer 2. Because MIMO layers 3 and 4 support a higher data rate, CCB3 and CCB4 are both mapped to MIMO layer 3, and CCB5 and CCB6 are both mapped to MIMO 4. The set of cross-block check blocks are transmitted over the four MIMO layers in a retransmission.

FIG. 9 illustrates an example of layer dependent link adaptation in which a set of cross-block check blocks is generated from multiple source packets. However, it should be understood that layer dependent link adaptation may also be used when each set of cross-block check blocks is generated from a respective packet.

Layer dependent link adaptation, using different MCS, can be implemented in different scenarios. In some examples, different MIMO layers have different channel quality indicator (CQI) values. For example, channel quality feedback may indicate a better channel condition in certain MIMO layers (e.g., in MIMO layers 3 and 4) than other MIMO layers (e.g., in MIMO layers 1 and 2), such that the MIMO layers having better CQI may support a higher data rate. In another example, such as in the case where different MIMO layers carry data from different transmitter nodes (e.g., in the case of multiple transmitter nodes cooperating in a MIMO transmission, discussed further below) certain MIMO layers may carry data from a transmitter node having better channel condition (e.g., in MIMO layers 3 and 4) while other MIMO layers carry data from another transmitter node having worse channel condition (e.g., in MIMO layers 1 and 2).

In general, the disclosed transmission schemes using cross-block check blocks may be used together with layer dependent link adaptation (e.g., robust to MCS and channel variations in different layers).

A retransmission that includes one or more cross-block check blocks may be performed based on feedback (from the receiver node) indicating whether a packet (sent in an initial transmission) was successfully decoded. There are different feedback schemes that may be used.

For example, in a NACK-based feedback scheme, a receiver node may transmit negative feedback (e.g., NACK) when any packet is not successfully decoded, otherwise no feedback is transmitted. In a NACK-based feedback scheme, the transmitter node may perform a retransmission using cross-block check blocks only if a NACK is received from the receiver node. If the transmitter node is performing a multicast or groupcast transmission, a retransmission may be performed if a NACK is received from any one receiver node (in some examples, the retransmission may be sent to all receiver nodes in the multicast or groupcast; in other examples, the retransmission may be sent only to the receiver node(s) that sent a NACK).

In another example, in an ACK-based feedback scheme, a receiver node may transmit positive feedback (e.g., ACK) when all packets are successfully decoded, otherwise no feedback is transmitted. An ACK-based feedback scheme may be used in the case of rateless code with a defined number of repetitions (i.e., the transmitter node performs an initial transmission of the packets and a defined number of retransmissions using cross-block check blocks), in which an ACK feedback terminates further repetitions by the transmitter node. If the transmitter node is performing a multicast or groupcast transmission, retransmissions may be performed up to the defined number of repetitions until an ACK is received from all target receiver nodes (in some examples, the retransmissions may be sent to all receiver nodes in the multicast or groupcast; in other examples, the retransmissions may be sent only to the receiver node(s) that have not sent an ACK).

In another example, in an ACK/NACK feedback scheme, a receiver node may transmit positive feedback (e.g., ACK) when all packets are successfully decoded, and may transmit negative feedback (e.g., NACK) when any packet is not successfully decoded. The behavior of the transmitter node may be similar to that of existing ACK/NACK feedback schemes using uplink control information (UCI) signaling.

Regardless of whether the feedback is a NACK-based, ACK-based or ACK/NACK feedback scheme, the feedback may be MIMO layer independent or MIMO layer dependent (e.g., depending on whether single-layer or multi-layer cross-block check blocks are used). MIMO layer independent feedback means that the feedback is not associated with any particular MIMO layer (or any particular one of the packets transmitted over the MIMO layers). In MIMO layer independent feedback, the receiver node transmits NACK feedback (in the case of NACK-based or ACK/NACK feedback scheme) if any one of the packets received over any one of the MIMO layers is not decoded successfully (conversely, the receiver node transmits ACK feedback (in the case of ACK-based or ACK/NACK feedback scheme) only if all the packets received over the MIMO layers are decoded successfully).

MIMO layer dependent feedback means that the feedback is associated with a specific MIMO layer. That is, the receiver node transmits feedback for each given MIMO layer depending on whether the packet received over the given MIMO layer MIMO layer was successfully decoded or not. MIMO layer dependent feedback may be useful if single-layer cross-block check blocks are used, because MIMO layer dependent feedback enables the transmitter node to generate cross-block check blocks and perform a retransmission only for the MIMO layer that has the feedback (e.g., NACK feedback or absence of ACK feedback, depending on feedback scheme) indicating a need for retransmission. For example, if a receiver node successfully decodes a first packet received over a first MIMO layer but was unsuccessful in decoding a second packet received over a second MIMO layer, the receiver node may transmit NACK feedback over the second MIMO layer. The transmitter node, in response, may generate cross-block check blocks using bits sampled from the CBs of the second packet and may perform a retransmission using the generated cross-block check blocks over the second MIMO layer. The transmitter node may not need to generate cross-block check blocks for the first packet and may retransmit more cross-block check blocks generated from the bits of the second packet (e.g. cross-block check blocks generated using a different interleaver that corresponds to a different RV) or the transmitter node may transmit new data over the first MIMO layer.

MIMO layer independent feedback may be relatively simple to implement and has relatively low feedback overhead. In addition, in the case with multiple-layer cross code block coding scheme, all layers may be jointly decoded which may help to improve reliability and performance and MIMO-layer dependent feedback may not be needed. MIMO layer dependent feedback may have more feedback overhead and may be only helpful for retransmissions using single-layer cross-block check blocks, however MIMO layer dependent feedback may enable more efficient use of resources.

The present disclosure also describes examples using cross-block check blocks in the context of multiple transmitter node cooperation (also referred to as multi-TRP cooperation). For example, two or more transmitter nodes may cooperate with each other to transmit packets to a receiver node. This may involve, for example, a portion of the packets being transmitted by a first transmitter node and the remaining packets being transmitted by a second transmitter node in the initial transmission, then a portion of the cross-block check blocks being transmitted by the first transmitter node and the remaining cross-block check blocks being transmitted by the second transmitter node in a retransmission. In another example, the first transmitter node may be responsible for transmitting the packets and the second transmitter node may be responsible for transmitting the cross-block check blocks in the same transmission opportunity (e.g., in the initial transmission).

Multiple transmitter nodes may cooperate with each other in various ways. In one example cooperation scheme, different transmitter nodes may transmit using orthogonal resources. That is, each transmitter node transmits over its own MIMO layers and using different scheduled time-frequency resources. In another example cooperation scheme, the MIMO layers and the MIMO precoders used by the cooperating transmitter nodes may be designed jointly to support the cooperation. It should be understood that there are various ways that multiple transmitter nodes may be configured to cooperate with each other, the details of which need not be further discussed here.

When there are multiple transmitter nodes operating in cooperation with each other, the total number of MIMO layers in a transmission is the total of all MIMO layers of all cooperating transmitter nodes. At the receiver node, the MIMO layers from the multiple transmitter nodes are received and decoded similar to the single transmitter node scenario. The receiver node may or may not have information about which transmitter node is transmitting over which MIMO layer. It may be noted that the total number of MIMO layers used by the cooperating transmitter nodes is constrained by the number of MIMO layers that may be received by the receiver node.

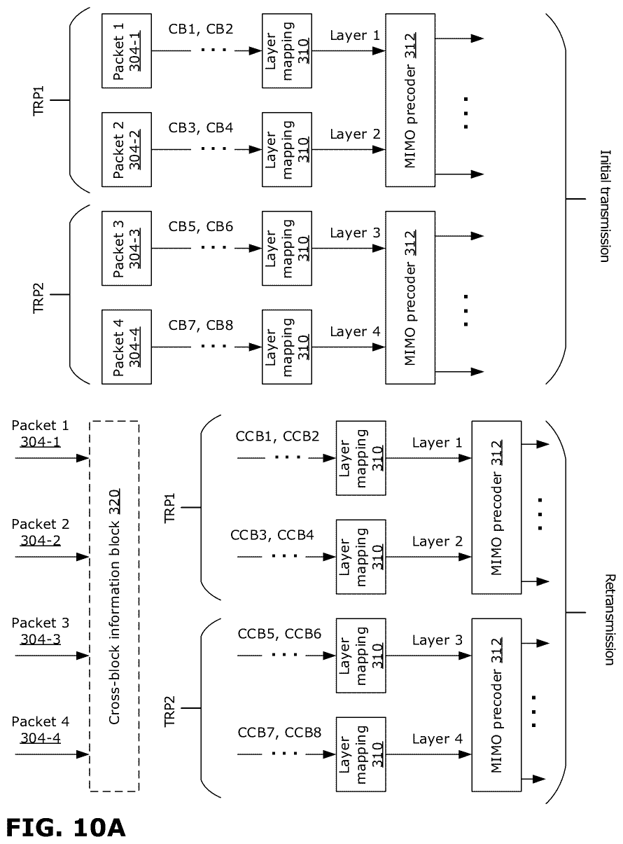

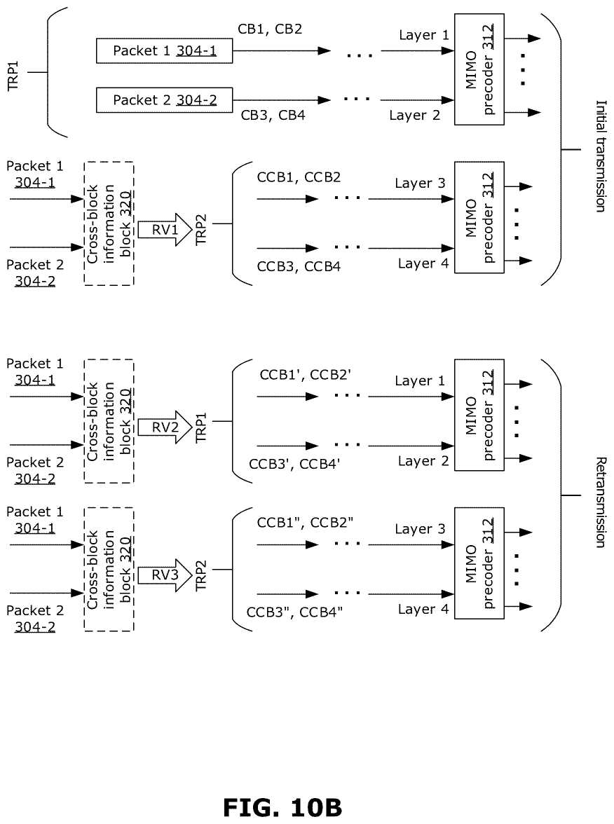

Some examples of how cross-block check blocks may be used in a multiple transmitter node cooperation scheme are now discussed. In an example, a set of cross-block check blocks may be generated using bits sampled from the CBs of a packet transmitted on a single MIMO layer of each cooperating transmitter node (e.g., single-layer cross-block check blocks, similar to the example shown in FIG. 7B). In another example, a set of cross-block check blocks may be generated using bits sampled from different packets transmitted over different MIMO layers of one cooperating transmitter node (e.g., similar to the example shown in FIG. 6B). In another example, a set of cross-block check blocks may be generated using bits sampled from different packets transmitted over different MIMO layers of multiple cooperating transmitter nodes (e.g., as shown in the example of FIG. 10A, discussed below). In another example, a first cooperating transmitter node may be used to transmit the source packets and a second cooperating transmitter node may be used to transmit the cross-block check blocks generated from the source packets (e.g., as shown in the example of FIG. 10B, discussed below). It should be understood that the examples are not intended to be limiting.

In an example where single-layer cross-block check blocks are used (i.e., the cross-block check blocks are generated using bits sampled from CBs transmitted over a single MIMO layer), each MIMO layer have its own RV index (which may be unique to each MIMO layer or there may be multiple MIMO layers that have the same RV index). As previously mentioned, each RV index may be associated with a respective interleaver that is used for generating cross-block check blocks. Examples of how each RV index may be associated with a respective interleaver used for generating cross-block check blocks are described in PCT application no. PCT/CN2021/121483, “METHODS AND APPARATUSES FOR WIRELESS COMMUNICATION RETRANSMISSION USING CHECK BLOCKS GENERATED ACCORDING TO SUBBLOCK INTERLEAVERS”, filed Sep. 28, 2021, the entirety of which is hereby incorporated by reference. Each set of cross-block check blocks (which are generated for each MIMO layer) may thus be generated using the interleaver associated with the RV index applied to the respective MIMO layer. When different RV indexes are used by different MIMO layers, there may be improvements in system performance due to the increase in information based on how the cross-block check blocks are generated differently.

If MIMO layer dependent feedback is used, each MIMO layer may use a different HARQ process (because the initial transmission and retransmissions on each MIMO layer can be decoded independently). If MIMO layer independent feedback is used, all MIMO layers may share the same HARQ process (because retransmissions use cross-block check blocks generated using bits sampled from across different MIMO layers).

FIG. 10A illustrates an example of cooperation between two transmitter nodes, in which the two transmitter nodes use the same RV index per transmission opportunity. For simplicity, FIG. 10A shows each transmitter node transmitting over two MIMO layers (for a total of four MIMO layers received at the receiver node). FIG. 10A also omits the operations for processing the packets 304 (namely packet 1 304-1, packet 2 304-2, packet 3 304-3 and packet 4 304-4) up until the layer mapping operation 310, and similarly omits the operations for generating the cross-block check blocks (namely CCB1 to CCB8) from the cross-block information block 320 up until the layer mapping operation 310.

In this example, the cooperation is between a first transmitter node (denoted TRP1) and a second transmitter node (denoted TRP2). However, it should be understood that more than two transmitter nodes may cooperate with each other. Cooperation between the first and second transmitter nodes may be configured by the first transmitter node, by the second transmitter node, or a third network node such as a controller node (not shown), for example. Configuration information for coordinating the cooperation between the first and second transmitter nodes may be transmitted using any suitable signaling, and need not be described in detail here. In particular, the configuration information may include information that is used to generate the cross-block check blocks (e.g., indicating the interleaver or RV index to use).

The packets 304 may originate from the first transmitter node, the second transmitter node, or a third network node such as a controller node (not shown), for example, and communicated (e.g., over backhaul link, uplink, downlink or sidelink) to the cooperating transmitter nodes. For the initial transmission, both the first and second transmitter nodes are configured to perform the transmission using RV index RV0 (i.e., both the first and second transmitter nodes transmit the source packets 304). In this example, each packet 304 is processed into two CBs. The first transmitter node transmits packet 1 304-1 (which consists of CB1 and CB2) over MIMO layer 1 and transmits packet 2 304-2 (which consists of CB3 and CB4) over MIMO layer 2. The second transmitter node transmits packet 3 304-3 (which consists of CB5 and CB6) over MIMO layer 3 and transmits packet 4 304-4 (which consists of CB7 and CB8) over MIMO layer 4.

For the retransmission, bits are sampled from all four packets 304 to form the cross-block information block 320, and the cross-block information block 320 is used to generate the cross-block check blocks CCB1 to CCB8. The cross-block information block 320 is shown using dashed lines in FIG. 10A to indicate that the cross-block information block 320 and generation of the cross-block check blocks CCB1 to CCB8 may be performed at the first transmitter node, the second transmitter node, or a third network node such as a controller node (not shown). In this example, because the cross-block check blocks CCB1 to CCB8 are generated using bits sampled from all four packets 304, the generation of the cross-block check blocks CCB1 to CCB8 may be performed by the same node that is the source of the packets 304. For example, if the packets 304 originate from the first transmitter node, the first transmitter node may generate the cross-block check blocks CCB1 to CCB8 and may communicate a subset of the cross-block check blocks (namely CCB5 to CCB8) to the second transmitter node.

In the retransmission, both the first and second transmitter nodes are configured to perform the transmission using RV index RV1. The first transmitter node transmits CCB1 and CCB2 over MIMO layer 1 and transmits CCB3 and CCB4 over MIMO layer 2. The second transmitter node transmits CCB5 and CCB6 over MIMO layer 3 and transmits CCB7 and CCB8 over MIMO layer 4.

In another example of multiple transmitter node cooperation, different RV indexes may be used for different MIMO layers in the same transmission opportunity. Each transmitter node may use a different RV index, for example.

FIG. 10B illustrates an example of cooperation between two transmitter nodes, in which the two transmitter nodes use different RV indexes per transmission opportunity. For simplicity, FIG. 10B shows each transmitter node transmitting over two MIMO layers (for a total of four MIMO layers received at the receiver node). FIG. 10B also omits the operations for processing the packets 304 (namely packet 1 304-1 and packet 2 304-2) and for mapping the packets 304 to the MIMO layers, and similarly omits the operations for generating the cross-block check blocks (namely CCB1 to CCB4) from the cross-block information block 320 and for mapping the cross-block check blocks to the MIMO layers.

Similar to the example of FIG. 10A, cooperation between the first and second transmitter nodes may be configured by the first transmitter node, by the second transmitter node, or a third network node such as a controller node (not shown), for example. It should be understood that more than two transmitter nodes may cooperate with each other. Configuration information for coordinating the cooperation between the first and second transmitter nodes may be transmitted using any suitable signaling, and need not be described in detail here. In particular, the configuration information may include information that is used to generate the cross-block check blocks (e.g., indicating the interleaver or RV index to use for each transmission).

The packets 304 may originate from the first transmitter node, the second transmitter node, or a third network node such as a controller node (not shown), for example, and communicated (e.g., over backhaul link, uplink, downlink or sidelink) to the cooperating transmitter nodes. Bits are sampled from both packet 1 304-1 and packet 2 304-2 to form the cross-block information block 320. The cross-block information block 320 is shown using dashed lines in FIG. 10B to indicate that the cross-block information block 320 and generation of a first set cross-block check blocks CCB1 to CCB4 may be performed at the first transmitter node, the second transmitter node, or a third network node such as a controller node (not shown). Because the cross-block check blocks CCB1 to CCB4 are generated using bits sampled from both packets 304, the generation of the cross-block check blocks CCB1 to CCB4 may be performed by the same node that is the source of the packets 304. For example, if the packets 304 originate from the first transmitter node, the first transmitter node may generate the cross-block check blocks CCB1 to CCB4 and may communicate the four cross-block check blocks to the second transmitter node. Alternatively, the first transmitter node may communicate the source packets 304 to the second transmitter node and the second transmitter node may itself generate the four cross-block check blocks.

In this example, the first transmitter node is configured to perform the transmission using RV index RV0 (i.e., transmit the source packets 304). In this example, each packet 304 is processed into two CBs. The first transmitter node transmits packet 1 304-1 (which consists of CB1 and CB2) over MIMO layer 1 and transmits packet 2 304-2 (which consists of CB3 and CB4) over MIMO layer 2. In the same transmission opportunity, the second transmitter node is configured to perform the transmission using RV index RV1 (i.e., transmission of a first set of cross-block check blocks generated using the interleaver associated with RV index RV1). The second transmitter node transmits CCB1 and CCB2 over MIMO layer 3 and transmits CCB3 and CCB4 over MIMO layer 4. Thus, the initial transmission includes transmission of the source packets 304 by the first transmitter node as well as cross-block check blocks by the second transmitter node. In this way, the initial transmission may be performed using different RV indexes for different MIMO layers.

A retransmission may be performed, where the first transmitter node is configured to perform the transmission using RV index RV2 and the second transmitter node is configured to perform the transmission using RV index RV3. This means that the first transmitter node transmits a second set of cross-block check blocks (denoted CCB1′ to CCB4′) generated using the interleaver associated with RV index RV2, and the second transmitter node transmits a third set of cross-block check blocks (denoted CCB1″ to CCB4″) generated using the interleaver associated with RV index RV3. Thus, the retransmission may also be performed using different RV indexes for different MIMO layers.

It should be understood that link adaptation may be used in the examples of FIGS. 10A and 10B, such that different MCS (e.g., QPSK, 16QAM, etc.) may be used by different MIMO layers. Further, it should be understood that although FIGS. 10A and 10B illustrate multiple transmitter node cooperation with multi-layer cross-block check blocks (i.e., the cross-block check blocks are generated using bits sampled from packets that are mapped to different MIMO layers), multiple transmitter node cooperation may also be used with single-layer cross-block check blocks (i.e., one set of cross-block check blocks is generated for each packet mapped to a single MIMO layer).

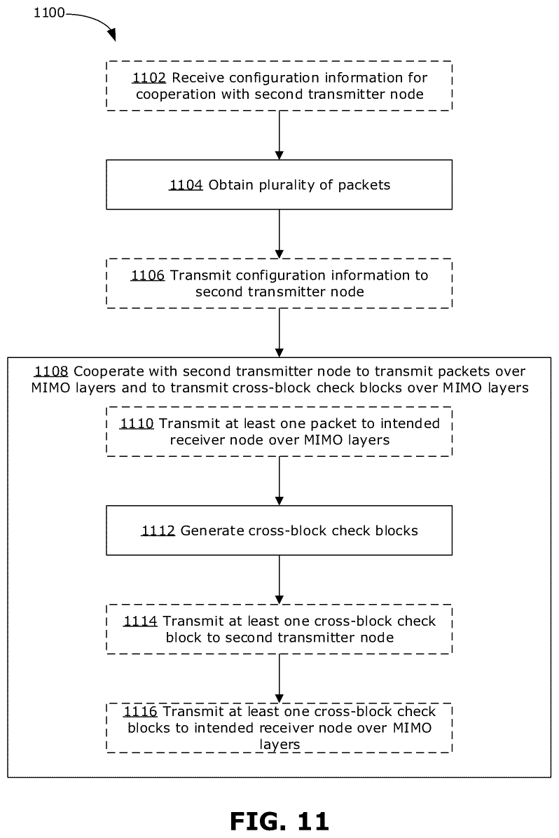

FIG. 11 is a flowchart illustrating an example method 1100, which may be performed by a first transmitter node that is cooperating with at least a second transmitter node to perform a transmission, including a transmission of a plurality of packets over a plurality of MIMO layers and a transmission of cross-block check blocks over the same or different plurality of MIMO layers. The method 1100 may be performed by a first transmitter node that is a BS 170, a TRP, a UE 110, or any other transmitter node. Similarly, the second transmitter node may be a cooperating BS 170, a cooperating TRP, or a cooperating UE 110, among other possibilities. It should be noted that cooperation between two or more transmitter nodes maybe performed in various ways, and is not necessarily limited to the examples described herein.

Optionally, at 1102, configuration information for cooperation with at least a second transmitter node is received. The configuration information may be received via configuration signaling, such as RRC signaling or DCI transmission. The configuration information may include information indicating which RV index the first transmitter node should use for at least the initial transmission. The configuration information may also include the RV indexes the first transmitter node should use for a defined number of retransmissions. The RV index indicates whether the first transmitter node is transmitting the original source packets in a transmission, or the interleaver to use for generating a set of cross-block check blocks for a transmission. Other information (e.g., which MIMO precoder to use, coding rate, etc.) that may be necessary for cooperation may also be included in the configuration information received at step 1102. The configuration information may be received from a network controller node or from the second transmitter node (e.g., received from an UL transmission, DL transmission, SL transmission or backhaul transmission), for example.

In some examples, step 1102 may not be performed. For example, the first transmitter node may itself generate the configuration information (which may be transmitted to the second transmitter node in optional step 1106 described below). In another example, the configuration information may be predetermined (e.g., defined in a standard) and may not need to be received explicitly.

At 1104, a plurality of packets are obtained. The packets may be obtained in various ways, as discussed in examples disclosed herein. For example, one or more of the packets may be obtained internally (e.g., generated internally). Additionally or alternatively, one or more packets may be received from a network controller node or from the second transmitter node (e.g., received from an UL transmission, DL transmission, SL transmission or backhaul transmission).

Optionally, at 1106, configuration information may be transmitted to the second transmitter node. The configuration information may be transmitted in a configuration signal, such as via RRC signaling or DCI transmission. Step 1106 may be performed in the case where the first transmitter node itself generates the configuration information. Alternatively, step 1106 may be performed in the case where the first transmitter node receives configuration information at step 1102 and forwards a copy of the configuration information to the second transmitter node at step 1106.

In some examples, the first transmitter node may transmit a copy of the plurality of packets to the second transmitter node, in addition to transmitting the configuration information at step 1106. For example, the first transmitter node may transmit a copy of the packets over a UL transmission, DL transmission, SL transmission or backhaul transmission. This may enable the second transmitter node to cooperate by transmitting the packets to the intended receiver node, or by using the packets to generate the cross-block check blocks that are then transmitted to the intended receiver node, for example.

In some examples, step 1106 may not be performed. For example, the second transmitter node may be the source of the configuration information received at step 1102. In another example, the second transmitter node may receive the configuration information from another network node. In another example, the configuration information may be predetermined (e.g., defined in a standard) and may not need to be communicated explicitly.

Optional steps 1102 and 1106 may be performed in any suitable order, such as prior to step 1104 or following step 1104.

At 1108, the first transmitter node cooperates with the second transmitter node to transmit the packets (obtained at step 1104) and to transmit cross-block check blocks (generated from the packets) over a plurality of MIMO layers. It should be understood that the first and second transmitter nodes may cooperate with each other to transmit the packets and the cross-block check blocks in various ways, such as discussed with respect to the examples of FIGS. 10A and 10B. For example, cooperation between the first and second transmitter nodes may be performed using any one or more of steps 1110, 1112, 1114 and/or 1116, depending on how the cooperation has been configured. In particular, cooperation between the first and second transmitter nodes may involve the generation of a set of cross-block check blocks by the first transmitter node.

At optional step 1110, the first transmitter node transmits at least one packet over one or more MIMO layers to the intended receiver node. For example, all of the packets obtained at step 1104 may be transmitted over a plurality of MIMO layers. In some examples, each packet may be transmitted over a respective one MIMO layer. In another example, a subset of the packets obtained at step 1104 may be transmitted over one or more MIMO layers, and the remainder of the packets may be transmitted by the second transmitter node.

In another example, step 1110 may be omitted and the packets obtained at step 1104 may not be transmitted by the first transmitter node. Instead, the second transmitter node may be responsible for transmitting the packets. In such a case, the packets obtained at step 1104 may be used by the first transmitter node for generating cross-block check blocks but may not be transmitted by the first transmitter node.

At 1112, the first transmitter node generates a set of cross-block check blocks using the plurality of packets obtained at step 1104. The set of cross-block check blocks may be generated using bits samples from across a plurality of different packets that are transmitted over different MIMO layers (i.e., multi-layer cross-block check blocks, similar to the cross-block check blocks generated in the method 600), or may be generated using cross-block bits from a packet transmitted over one MIMO layer (i.e., single-layer cross-block check blocks, similar to the cross-block check blocks generated in the method 700). The set of cross-block check blocks may be generated in accordance with the configuration information (e.g., received at step 1102), for example by using an interleaver associated with a configured RV index.

Optionally, at 1114, at least one generated cross-block check block is transmitted by the first transmitter node to the second transmitter node (e.g., via UL transmission, DL transmission, SL transmission or backhaul transmission). The second transmitter node may then transmit the at least one cross-block check block over its own MIMO layers to the intended receiver node. In some examples, the transmission of the at least one cross-block check block by the second transmitter node may be in the same transmission opportunity as the transmission of at least one packet (at optional step 1110). For example, as shown in the example of FIG. 10B, the first transmitter node may transmit the packets and the second transmitter node may transmit the cross-block check blocks in the same initial transmission.

It may be noted that, depending on the cooperation between the first and second transmitter nodes, step 1112 may be omitted for one of the transmitter nodes. For example, the first transmitter node may only transmit the original code blocks of the packets and does not transmit cross-block check blocks to the intended receiver node. Instead, the first transmitter node can send the packets to the second transmitter node and the second transmitter node may generate the cross-block check blocks and transmit at least one cross-block check block to the intended receiver node over MIMO layers. Then, instead of step 1114 being performed, the second transmitter node may itself generate the cross-block check blocks.

In some examples, the first transmitter node may, instead of performing step 1112 to generate the cross-block check blocks itself, configure the second transmitter node (e.g., using sidelink signaling) to generate and transmit the cross-block check blocks to the intended recipient node (or back to the first transmitter node which then transmits the cross-block check blocks to the intended recipient node). In other examples, one of the first and second transmitter nodes may be configured by another network node (e.g., a centralized network node) to generate the cross-block check blocks. The configuration signaling from the first transmitter node or the centralized network node may include, but is not limited to, an indication of the cross-block check blocks to be transmitted, an indication of the MIMO precoder to be used, an indication of the method to map the cross-block check blocks to the MIMO layers, as well as typical scheduling information (e.g., time frequency resource, MCS, RV used for the transmission, etc.). The configuration signaling can be part of backhaul signaling, higher layer signaling (e.g., RRC signaling) or physical layer signaling (e.g., DCI), for example.

It should be noted that, in general, the steps illustrated in FIG. 11 do not necessarily have to be performed in the order shown. For example, step 1110 may not necessarily be performed before steps 1112 and 1114; in some scenarios, step 1110 may be performed in parallel to steps 1112 and 1114 or after steps 1112 and 1114, among other possibilities.

In some examples, all of the generated cross-block check blocks may be transmitted to the second transmitter node. In other examples, a subset of the cross-block check blocks may be transmitted to the second transmitter node (and the second transmitter node in turn transmits the subset of cross-block check blocks to the intended receiver node). The remainder of the cross-block check blocks may be transmitted by the first transmitter node to the intended receiver node at step 1116.

At optional step 1116, at least one generated cross-block check block is transmitted by the first transmitter node over one or more MIMO layers to the intended receiver node. For example, if a set of multi-layer cross-block check blocks was generated, the cross-block check blocks may be mapped to and transmitted over a plurality of MIMO layers similar to the method 600. In another example, if a set of single-layer cross-block check blocks were generated for each packet that is transmitted over a single respective MIMO layer, then each set of single-layer cross-block check blocks may be transmitted over the single respective MIMO layer corresponding to its source packet (similar to the method 700).

In some examples, both steps 1114 and 1116 may be performed, such that the first and second transmitter nodes cooperate to transmit the generated cross-block check blocks (in the same or different transmission opportunity). In other examples, only step 1114 or only step 1116 may be performed, such that the generated cross-block check blocks are transmitted by only the first transmitter node or only the second transmitter node.

It should be noted that the transmission of the packets and the transmission cross-block check blocks may be performed in the same transmission opportunity or in different transmission opportunities (e.g., as illustrated in the examples of FIGS. 10A and 10B). Thus, steps 1110, 1112, 1114 and 1116 may take place in any suitable order, and not necessarily in the order illustrated in FIG. 11.

As previously mentioned, the first and second transmitter nodes may cooperate to transmit the CBs and the cross-block check blocks in various ways. For example, the first transmitter node may be responsible for transmitting the original packet(s) to the intended receiver node and the second transmitter node may (after receiving a copy of the packet(s), for example from the first transmitter node) generate the cross-block check blocks and transmit the generated cross-block check blocks to the intended receiver node. In another example, the first transmitter node may be responsible for transmitting the original packet(s) to the intended receiver node and also generating the cross-block check blocks, and the second transmitter node may (after receiving the cross-block check blocks from the first transmitter node) be responsible for transmitting the cross-block check blocks to the intended receiver node. In yet another example, the first transmitter node may be responsible for generating the cross-block check blocks and transmitting the cross-block check blocks to the intended receiver node, and the second transmitter node may (after receiving a copy of the packet(s) from the first transmitter node) be responsible for transmitting the original packet(s) to the intended receiver node. Thus, it should be understood that various ways of cooperative transmission may be used with the cross-block check blocks of the present disclosure.

The cooperation between the first and second transmitter nodes may be configured by another network node (e.g., a centralized network node). In other examples, one of the first and second transmitter nodes may configure the other transmitter node to enable cooperative transmission. In some examples, the other network node may also be the source of packet(s) that are cooperatively transmitted by the first and second transmitter nodes. It should be understood that there are different ways in which cooperation among multiple transmitter nodes may be configured, and that there may be cooperation among more than two transmitter nodes. The present disclosure should not be limited to the examples described. The configuration signaling from the first transmitter node or the centralized network node may include, but is not limited to, an indication of the cross-block check blocks to be transmitted, an indication of the MIMO precoder to be used, an indication of the method to map the cross-block check blocks, as well as typical scheduling information (e.g., time and frequency resource, MCS, RV used for the transmission, etc.). The configuration signaling can be part of backhaul signaling, higher layer signaling (e.g., RRC signaling) or physical layer signaling (e.g., DCI), for example.

It should be understood that examples described above, in which a packet 304 can be a single TB, can include a single CB, or can include multiple CBs, are also applicable in the scenario where multiple transmitter nodes are in cooperation with each other. Further, the example where a single packet is transmitted over a plurality of MIMO layers (e.g., as described with reference to FIGS. 8A and 8B) may also be applicable to the scenario where multiple transmitter nodes cooperate with each other. In general, one skilled in the art would understand that examples described herein that are performed solely by a single transmitter node may be adapted for the case where two or more transmitter nodes are in cooperation with each other. It should also be understood that any method of generating cross-block check blocks and transmitting the cross-block check blocks over one or more MIMO layers, as disclosed herein, may be used together in the context of cooperation among two or more transmitter nodes.

In general, regardless of whether multiple transmitter node cooperation is used, a transmitter node may be configured for MIMO transmission and generating the cross-block check blocks using a particular retransmission scheme via scheduling information. For example, a BS 170 or other network controller node may transmit scheduling information in a control signal to the transmitter node. A BS 170 or the transmitter node may also send scheduling information to the intended receiver node in a control signal. The control signal may be sent via dynamic signaling (e.g., DCI) or semi-static signaling (e.g., RRC).

The control information may include, for example, an indicator of whether or not to use cross-block check blocks as disclosed herein. The control information may also indicate how packets should be mapped to MIMO layers (e.g., 1 packet to 1 MIMO layer or 1 packet to multiple MIMO layers, or indicator of some predefined mapping rule). The control information may also indicate whether cross-block check blocks are generated using bits sample from CBs transmitted over a single MIMO layer or over multiple MIMO layers (and if multiple MIMO layers, which of the MIMO layers).

The control information may also include an indicator of the RV index to use, or the sequence of RV indexes to use for a predefined number of transmissions. In general, an RV index of RV0 may indicate a transmission of the original code block(s) without any cross-block check block(s), which usually corresponds to an initial transmission of the source packet(s), and other RV indexes (e.g., RV1, RV2, etc.) may be associated with a respective interleaver to use for generating the cross-block check blocks. The control information may also include the HARQ process ID. For example, a single HARQ ID can be used if the feedback from the receiver node is not packet-specific (e.g., the feedback is MIMO layer independent), or a list of HARQ process ID corresponding to each packet may be provided if the feedback from the receiver node is packet-specific (e.g., the feedback is MIMO layer dependent).

Similar control information may be provided to the receiver node via dynamic signaling (e.g., DCI) or semi-static signaling (e.g., RRC), so that the receiver node has sufficient information to recover the received packets. In particular, the receiver node may be provided with information about how the cross-block check blocks were generated and transmitted (e.g., RV index, MIMO layer mapping, etc.), so that the cross-block check blocks may be decoded. If multiple transmitter nodes are cooperating to perform a transmission, the control information provided to the receiver node may or may not inform the receiver node about which MIMO layers originate from which transmitter node. Soft information from decoding of the cross-block check blocks may be used to assist in decoding of the packets.

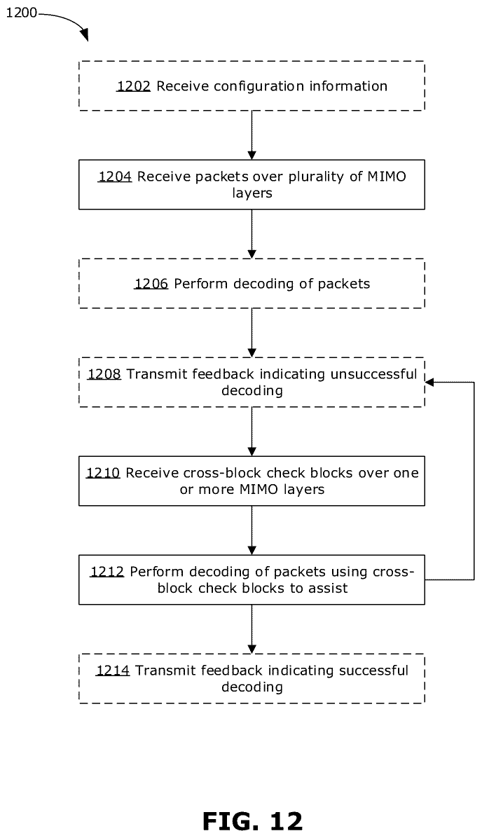

FIG. 12 is a flowchart illustrating an example method 1200, which may be performed by a receiver node.

Optionally, at 1202, the receiver node may receive configuration information. The configuration information may provide information to enable the receiver node to recover packets received over a plurality of MIMO layers. The configuration information may also include any of the control information described above, for example.

At 1204, a plurality of packets is received over the plurality of MIMO layers. The packets may be received over MIMO layers of a single transmitter node, or over MIMO layers of two or more different transmitter nodes. The receiver node may or may not have information about which MIMO layers are received from which transmitter node, and may or may not have information about whether or not multiple transmitter nodes are involved in the transmission of the plurality of packets.

Optionally, at 1206, the receiver node may perform decoding of the received packets. In some examples, the decoding attempt may be performed after the cross-block check blocks are also received (e.g., if both the packets and the cross-block check blocks are received in the same transmission opportunity).

If decoding of the received packets was attempted, the decoding of one or more of the received packets may be unsuccessful. Optionally, at 1208, the receiver node may transmit feedback (e.g., NACK) to the transmitter node indicating decoding was unsuccessful. The feedback may be MIMO layer independent or MIMO layer dependent. In other examples, the absence of feedback from the receiver node may indicate that decoding was unsuccessful. In other examples, there may be no feedback from the receiver node regardless of whether decoding was successful or not.

At 1210, the receiver node receives a set of cross-block check blocks over one or more MIMO layers. The cross-block check blocks may have been generated from bits selected from across packets mapped to different MIMO layers (i.e., multi-layer cross-block check blocks), or may have been generated from bits selected from across CBs of a packet mapped to a single MIMO layer (i.e., single-layer cross-block check blocks). For example, if the feedback transmitted at step 1208 is MIMO layer dependent feedback and specific to a single MIMO layer, the set of cross-block check blocks may be single-layer cross-block check blocks generated from the CBs mapped to the single MIMO layer. If, at step 1204, the plurality of packets was received from different transmitter nodes and MIMO layer dependent feedback was used at step 1208, then only the transmitter node that received negative feedback may generate and transmit a set of cross-block check blocks to the receiver node.

In some examples, the cross-block check blocks and the packets may be received in the same transmission opportunity, over different MIMO layers.

At 1212, the receiver node performs decoding of the packets using the received cross-block check blocks to assist in decoding. As discussed above, soft information from decoding of the cross-block check blocks may be used to assist in decoding of the packets. The receiver node may combine the originally received packets (that include the original code blocks) as well as the received cross-block check blocks to jointly decode the packets. The originally received packets and the received cross-block check blocks may be received from one or multiple transmit points (e.g., from different transmitter nodes and/or from a centralized network node) in various ways as discussed above.

If decoding of the packets is still unsuccessful (e.g., at least one received packet could not be successfully decoded), the method 1200 may return to optional step 1208.

If decoding of the packets is successful, the method 1200 may proceed to optional step 1214.

Optionally, at 1214, the receiver node may transmit feedback (e.g., ACK) to the transmitter node indicating decoding was unsuccessful. The feedback may be MIMO layer independent or MIMO layer dependent. In other examples, the absence of feedback from the receiver node may indicate that decoding was successful. In other examples, there may be no feedback from the receiver node regardless of whether decoding was successful or not.

In various examples the present disclosure has described apparatuses and methods for performing MIMO transmissions using a HARQ retransmission scheme, in which cross-block check blocks are transmitted. Cross-block check blocks may be generated using bits selected from across packets mapped to different MIMO layers (multi-layer cross-block check blocks). Cross-block check blocks may also be generated using bits selected from across the CBs of a single packet mapped to a single MIMO layer (single-layer cross-block check blocks). Examples of the present disclosure may be used for MIMO layer independent feedback or MIMO layer dependent feedback.

Examples of the present disclosure may enable additional gain from fewer redundant retransmissions being performed on already decoded CBs. Examples of the present disclosure may also provide additional diversity gain from joint decoding across multiple MIMO layers. For example, due to the joint decoding across multiple MIMO layers for both initial transmission and retransmission, the system performance may be more robust to variations in channel quality across different MIMO layers as well as enabling the use of different MCS for more reliable layer dependent link adaption.

In some examples, different RV indexes may be applied to different MIMO layers, which may provide improved IR performance for soft combining. In some examples, cross-block check blocks may be transmitted in the same transmission opportunity as the source packets (e.g., by applying different RV indexes to different MIMO layers). This may help to reduce latency.

The present disclosure also describes examples in which the disclosed cross-block check blocks are used for MIMO transmissions in the context of multiple transmitter node cooperation. Cooperation among multiple transmitter nodes may provide further diversity gain.

Examples of the present disclosure may be useful for large packet URLLC applications, although this is not intended to be limiting. Examples of the present disclosure may also be useful in any application that would benefit from improved reliability and/or reduced latency, such as enhanced mobile broadband (eMBB) applications.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method, at a receiver node, comprising:
receiving a plurality of packets over a plurality of multiple-input multiple-output (MIMO) layers;
receiving a set of cross-block check blocks generated from a plurality of bits selected from across two or more of the plurality of packets received over respective two or more MIMO layers; and
decoding the plurality of packets using the set of cross-block check blocks to assist in decoding of the plurality of packets.

2. The method of claim 1, wherein the plurality of packets is received over the plurality of MIMO layers in an initial transmission, and wherein the set of cross-block check blocks is received over one or more MIMO layers, different from the plurality of MIMO layers, in the initial transmission.

3. The method of claim 1, further comprising:
after receiving the plurality of packets, attempting to decode the plurality of packets and transmitting feedback indicating decoding of the plurality of packets was unsuccessful; and
receiving the set of cross-block check blocks in a retransmission after transmitting the feedback.

4. The method of claim 1, wherein the plurality of packets is received from two or more different transmitter nodes over the plurality of MIMO layers.

5. The method of claim 4, wherein the set of cross-block check blocks is received from at least one of the two or more different transmitter nodes.

6. A method, at a transmitter node, comprising:
obtaining a packet to be transmitted to an intended receiver node over a plurality of multiple-input multiple-output (MIMO) layers;
generating a set of one or more cross-block check blocks using a plurality of bits selected from across two or more code blocks of the packet; and
transmitting the set of one or more cross-block check blocks over one or more MIMO layers.

7. The method of claim 6, further comprising:
transmitting the packet over the plurality of MIMO layers in an initial transmission, the plurality of MIMO layers being a first subset of available MIMO layers at the transmitter node;
wherein the set of one or more cross-block check blocks is transmitted over a MIMO layer not included in the first subset, the set of one or more cross-block check blocks being transmitted with the packet in the initial transmission.

8. The method of claim 6, further comprising:
transmitting the packet over the plurality of MIMO layers in an initial transmission; and
transmitting the set of one or more cross-block check blocks over the one or more MIMO layers in a retransmission.

9. The method of claim 8, wherein the set of one or more cross-block check blocks is transmitted in the retransmission in absence of any feedback.

10. The method of claim 6, wherein the plurality of bits selected from across two or more code blocks of the packet is selected using a set of interleavers associated with a redundancy version (RV) index.

11. An apparatus comprising:
a processing unit; and
a non-transitory memory including instructions that, when executed by the processing unit, cause the apparatus to:
receive a plurality of packets over a plurality of multiple-input multiple-output (MIMO) layers;
receive a set of cross-block check blocks generated from a plurality of bits selected from across two or more of the plurality of packets received over respective two or more MIMO layers; and
decode the plurality of packets using the set of cross-block check blocks to assist in decoding of the plurality of packets.

12. The apparatus of claim 11, wherein the plurality of packets is received over the plurality of MIMO layers in an initial transmission, and wherein the set of cross-block check blocks is received over one or more MIMO layers, different from the plurality of MIMO layers, in the initial transmission.

13. The apparatus of claim 11, wherein the instructions further cause the apparatus to:
after receiving the plurality of packets, attempt to decode the plurality of packets and transmit feedback indicating decoding of the plurality of packets was unsuccessful; and
receive the set of cross-block check blocks in a retransmission after transmitting the feedback.

14. The apparatus of claim 11, wherein the plurality of packets is received from two or more different transmitter nodes over the plurality of MIMO layers.

15. The apparatus of claim 14, wherein the set of cross-block check blocks is received from at least one of the two or more different transmitter nodes.

16. An apparatus comprising:
a processing unit; and
a non-transitory memory including instructions that, when executed by the processing unit, cause the apparatus to:
obtain a packet to be transmitted to an intended receiver node over a plurality of multiple-input multiple-output (MIMO) layers;
generate a set of one or more cross-block check blocks using a plurality of bits selected from across two or more code blocks of the packet; and
transmit the set of one or more cross-block check blocks over one or more MIMO layers.

17. The apparatus of claim 16, wherein the instructions further cause the apparatus to:
transmit the packet over the plurality of MIMO layers in an initial transmission, the plurality of MIMO layers being a first subset of available MIMO layers at the transmitter node;
wherein the set of one or more cross-block check blocks is transmitted over a MIMO layer not included in the first subset, the set of one or more cross-block check blocks being transmitted with the packet in the initial transmission.

18. The apparatus of claim 16, wherein the instructions further cause the apparatus to:
transmit the packet over the plurality of MIMO layers in an initial transmission; and
transmit the set of one or more cross-block check blocks over the one or more MIMO layers in a retransmission.

19. The apparatus of claim 18, wherein the set of one or more cross-block check blocks is transmitted in the retransmission in absence of any feedback.

20. The apparatus of claim 16, wherein the plurality of bits selected from across two or more code blocks of the packet is selected using a set of interleavers associated with a redundancy version (RV) index.
